(19) United States
(12) Patent Application Publication
(10) Pub. No.: US 2011/0269928 A1
(43) Pub. Date: Nov. 3, 2011

(54) PROCESS FOR PRODUCING SOLID CATALYST COMPONENT FOR OLEFIN POLYMERIZATION

(75) Inventors: Yasuki FUJIWARA, Chiba (JP); Wataru HIRAHATA, Chiba (JP)

(73) Assignee: SUMITOMO CHEMICAL COMPANY, LIMITED, Tokyo (JP)

(21) Appl. No.: 13/094,309

(22) Filed: Apr. 26, 2011

(30) Foreign Application Priority Data
Apr. 28, 2010 (JP) 2010-104106

(51) Int. Cl. C08F 4/654; B01J 31/14; C08F 10/06; B01J 31/12

(52) U.S. Cl. 526/124.9; 502/104

(57) ABSTRACT

The present invention aims at providing a solid catalyst component for olefin polymerization, the solid catalyst composed being capable of showing a sufficiently high polymerization activity and providing a polymer having a low content of a low molecular weight component or an amorphous component; a process for producing the solid catalyst component; and a process for producing a solid catalyst for olefin polymerization, and a process for producing an olefin polymer. This object can be achieved by a process for producing a solid catalyst component (A), the process including: step (1) of producing a precursor of the solid catalyst component by adding an organomagnesium compound (c) to a titanium compound (b) represented by Formula (I) in the presence of a silicon compound containing a Si—O bond (a); and step (2) of producing the solid catalyst component (A) by bringing the precursor of the solid catalyst component, a halogenated metal compound represented by Formula (II) and an internal electron donor represented by Formula (III) into contact with each other.

### BACKGROUND OF THE INVENTION

1. Field of the Invention

The present application claims the Paris Convention priority based on Japanese Patent Application No. 2010-104106 filed on Apr. 28, 2010, the entire content of which is incorporated herein by reference.

The present invention relates to a process for producing a solid catalyst component for olefin polymerization; a process for producing a solid catalyst for olefin polymerization; and a process for producing an olefin polymer using the solid catalyst.

2. Description of the Related Art

Various solid catalyst components containing a titanium atom, a magnesium atom, a halogen atom and an internal electron donor have hitherto been proposed as a catalyst component for olefin polymerization. It is required for the catalyst obtained using such a solid catalyst component to show a high polymerization activity and to give a polymer having a low content of a low molecular weight component or an amorphous component, when an olefin is polymerized in the presence of the catalyst.

For example, JP-A-1-319508 discloses that when an α-olefin is polymerized in the presence of a mixture of a Ti—Mg composite solid catalyst, which is obtained by reducing a tetravalent titanium compound with an organomagnesium compound in the presence of an organosilicon compound, an organoaluminum compound as a co-catalyst, and an organosilicon compound, the mixture shows a high polymerization activity and gives an α-olefin polymer having a low content of a low molecular weight component or an amorphous component.

JP-A-2-289604 and JP-A-8-143619 disclose a solid catalyst component, which is obtained by bringing a magnesium compound, a titanium compound, a halogen-containing compound and an alkoxyester compound into contact with each other, and a solid catalyst component, which is obtained by bringing a magnesium compound, a titanium compound and a halogen-containing compound into contact with each other, and then bringing the resulting mixture into contact with an alkoxyester compound.

### SUMMARY OF THE INVENTION

The catalyst for olefin polymerization containing a solid catalyst component, however, is not satisfactory from the viewpoint of the polymerization activity, and the content of the low molecular weight component or the amorphous component contained in the olefin polymer obtained by polymerizing an olefin in the presence of the catalyst. The present invention aims at providing a process for producing a solid catalyst for olefin polymerization, the catalyst being capable of showing a sufficiently high polymerization activity and providing a polymer having a low content of a low molecular weight component or an amorphous component; a process for producing a solid catalyst component for olefin polymerization, which solid catalyst component is to be used for producing a solid catalyst for olefin polymerization; and a process for producing an olefin polymer using the solid catalyst.

The present invention provides a process for producing a solid catalyst component (A) for olefin polymerization, the process comprising:

step (1) of producing a precursor of the solid catalyst component by adding an organomagnesium compound (c) to a titanium compound (b) represented by Formula (I) in the presence of a silicon compound containing a Si—O bond (a),

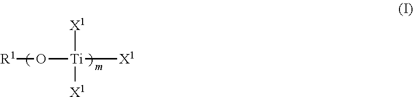

where m is an integer number of 1 to 20; R¹ is a hydrocarbyl group having 1 to 20 carbon atoms; X¹ each independently is a halogen atom or a hydrocarbyloxy group having 1 to 20 carbon atoms, and

step (2) of producing the solid catalyst component (A) by bringing the precursor of the solid catalyst component, a halogenated metal compound represented by Formula (II) and an internal electron donor represented by the Formula (III) into contact with each other

MX²_{b}(R²)_{m-b} (II)

where M is a Group 4 element, a Group 13 element or a Group 14 element; R² is an alkyl group, an aryl group, an alkoxy group or an aryloxy group each having 1 to 20 carbon atoms; X² is a halogen atom; m is the valency of M; b is an integer number satisfying 0<b≦m,

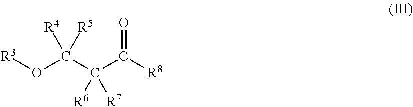

where R³ is a hydrocarbyl group having 1 to 20 carbon atoms; R⁴, R⁵, R⁶ and R⁷ are each independently a hydrogen atom, a halogen atom or a hydrocarbyl group having 1 to 20 carbon atoms; and R⁸ is a halogen atom or a hydrocarbyloxy group having 1 to 20 carbon atoms.

The present invention further provides a process for producing a solid catalyst for olefin polymerization, the process comprising a step of bringing a solid catalyst component (A) produced by the above process, an organoaluminum compound (B) and an external electron donor (C) into contact with each other.

The present invention further provides a process for producing an olefin polymer, the process comprising a step of polymerizing an olefin in the presence of a solid catalyst produced by the above process.

That is, the present invention provides the following.

(1) A process for producing a solid catalyst component (A) for olefin polymerization, the process comprising:

step (1) of producing a precursor of the solid catalyst component by adding an organomagnesium compound (c) to a titanium compound (b) represented by Formula (I) in the presence of a silicon compound containing a Si—O bond (a),

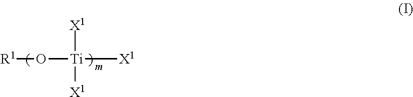

where m is an integer number of 1 to 20; R¹ is a hydrocarbyl group having 1 to 20 carbon atoms; X¹ each independently is a halogen atom or a hydrocarbyloxy group having 1 to 20 carbon atoms, and

step (2) of producing the solid catalyst component (A) by bringing the precursor of the solid catalyst component, a halogenated metal compound represented by Formula (II) and an internal electron donor represented by the Formula (III) into contact with each other,

MX²_{b}(R²)_{m-b} (II)

where M is a Group 4 element, a Group 13 element or a Group 14 element; R² is an alkyl group, an aryl group, an alkoxy group or an aryloxy group each having 1 to 20 carbon atoms; X² is a halogen atom; m is the valency of M; b is an integer number satisfying 0<b≦m,

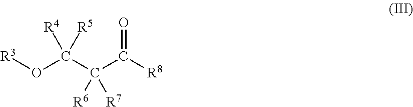

where R³ is a hydrocarbyl group having 1 to 20 carbon atoms; R⁴, R⁵, R⁶ and R⁷ are each independently a hydrogen atom, a halogen atom or a hydrocarbyl group having 1 to 20 carbon atoms; and R⁸ is a halogen atom or a hydrocarbyloxy group having 1 to 20 carbon atoms.
(2) The process according to the item (1), wherein R⁴ and R⁵ are hydrogen atoms.
(3) The process according to the items (1) or (2), wherein R⁶ is an alkyl group having 1 to 20 carbon atoms or an aryl group having 6 to 20 carbon atoms.
(4). The process according to the item (3), wherein R⁶ is a branched or cyclic group each having 3 to 20 carbon atoms, or an aryl group having 6 to 20 carbon atoms.
(5). A process for producing a solid catalyst for olefin polymerization, the process comprising a step of bringing a solid catalyst component (A) produced by the process according to any one of the items (1) to (4) into contact with an organoaluminum compound (B).
(6). A process for producing a solid catalyst for olefin polymerization, the process comprising a step of bringing a solid catalyst component (A) produced by the process according to any one of the items (1) to (4), an organoaluminum compound (B) and an external electron donor (C) into contact with each other.
(7). A process for producing an olefin polymer, the process comprising a step of polymerizing an olefin in the presence of a solid catalyst produced by the process according to the item (5) or (6).
(8). The process for producing an olefin polymer according to the item (7), wherein the olefin is an α-olefin having 3 to 20 carbon atoms.

According to the present invention, a process for producing a solid catalyst for olefin polymerization, the solid catalyst being capable of showing a sufficiently high polymerization activity and providing a polymer having a low content of a low molecular weight component or an amorphous component; a process for producing a solid catalyst component for olefin polymerization, which solid catalyst component is to be used for producing the solid catalyst for olefin polymerization; and a process for producing an olefin polymer using the solid catalyst for olefin polymerization can be provided.

### DETAILED DESCRIPTION OF THE INVENTION

The process for producing a solid catalyst component (A) of the present invention for olefin polymerization comprises step (1) of producing a precursor of a solid catalyst component by adding an organomagnesium compound (c) to a titanium compound (b) represented by Formula (I) in the presence of a silicon compound containing a Si—O bond (a),

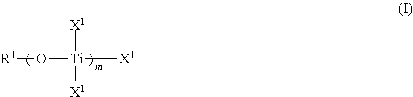

where m is an integer number of 1 to 20; R¹ is a hydrocarbyl group having 1 to 20 carbon atoms; and X¹ is each independently a halogen atom or a hydrocarbyloxy group having 1 to 20 carbon atoms.

Examples of the silicon compound containing a Si—O bond (a) include compounds represented by Formulae (i) to (iii):

Si(OR⁹)ₜR¹⁰₍₄₋ₜ₎ (i)

R¹¹(R¹²₂SiO)ᵤSiR¹³₃ (ii)

(R¹⁴₂Sio)ᵥ (iii)

where each of R⁹ to R¹⁴ is independently a hydrocarbyl group having 1 to 20 carbon atoms or a hydrogen atom; t is an integer number of 1 to 4; u is an integer number of 1 to 1000; and v is an integer number of 2 to 1000.

Examples of the hydrocarbyl group for each of R⁹ to R¹⁴ in Formulae (i) to (iii) include alkyl groups such as a methyl group, an ethyl group, a n-propyl group, an isopropyl group, a n-butyl group, an isobutyl group, a n-pentyl group, an isopentyl group, a hexyl group, a heptyl group, an octyl group, a decyl group and a dodecyl group; aryl groups such as a phenyl group, a tolyl group, a xylyl group and a naphthyl group; cycloalkyl groups such as a cyclohexyl group and a cyclopentyl group; alkenyl groups such as an allyl group; and aralkyl groups such as a benzyl group.

In Formulae (i) to (iii), each of R⁹ to R¹⁴ is preferably an alkyl group having 2 to 18 carbon atoms, or an aryl group having 6 to 18 carbon atoms, particularly preferably a linear alkyl group having 2 to 18 carbon atoms.

Specific examples of the silicon compound containing a Si—O bond (a) represented by any of Formulae (i) to (iii) include tetramethoxysilane, dimethyldimethoxysilane, tetraethoxysilane, triethoxyethylsilane, diethoxydiethylsilane, ethoxytriethylsilane, tetraisopropoxysilane, diisopropoxydiisopropylsilane, tetrapropoxysilane, dipropoxydipropylsilane, tetrabutoxysilane, dibutoxydibutylsilane, dicyclopentoxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane, and phenylhydropolysiloxane.

Of the silicon compound containing a Si—O bonds (a) represented by Formulae (i) to (iii), tetraalkoxysilanes, i.e., compounds represented by Formula (i) wherein t is 4 are preferable, and tetraethoxysilane is the most preferable.

Examples of the titanium compound (b) include compounds represented by Formula (I).

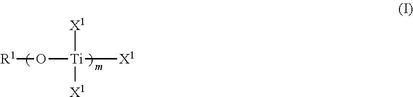

where m is an integer number of 1 to 20; R¹ is a hydrocarbyl group having 1 to 20 carbon atoms; and X¹ is each independently a halogen atom or a hydrocarbyloxy group having 1 to 20 carbon atoms.

Examples of R¹ include alkyl groups such as a methyl group, an ethyl group, a n-propyl group, an isopropyl group, a n-butyl group, an isobutyl group, a n-pentyl group, an isopentyl group, a n-hexyl group, a n-heptyl group, a n-octyl group, a n-decyl group, and a n-dodecyl group; aryl groups such as a phenyl group, a tolyl group, a xylyl group and a naphthyl group; cycloalkyl groups such as a cyclohexyl group and a cyclopentyl group; alkenyl groups such as an allyl group; and aralkyl groups such as a benzyl group. Examples of preferable R¹ include an alkyl group having 2 to 18 carbon atoms, and an aryl group having 6 to 18 carbon atoms, and a linear alkyl group having 2 to 18 carbon atoms is particularly preferable.

Examples of the halogen atom for X¹ include a chlorine atom, a bromine atom, and an iodine atom. A chlorine atom is particularly preferable.

The hydrocarbyloxy group having 1 to 20 carbon atoms for X¹ is preferably an alkoxy group having 2 to 18 carbon atoms, more preferably an alkoxy group having 2 to 10 carbon atoms, and particularly preferably an alkoxy group having 2 to 6 carbon atoms.

Examples of the titanium compound (b) include tetramethoxytitanium, tetraethoxytitanium, tetra-n-propoxytitanium, tetraisopropoxytitanium, tetra-n-butoxytitanium, tetraisobutoxytitanium, n-butoxytitanium trichloride, di-n-butoxytitanium dichloride, tri-n-butoxytitanium chloride, tetraisopropylpolytitanate, which is a mixture of compounds of Formula (I) where m is within a range of 2 to 10, tetra-n-butyl polytitanate (a mixture of compounds of Formula (I) where m is within a range of 2 to 10), tetra-n-hexyl polytitanate, which is a mixture of compounds of Formula (I) where m is within a range of 2 to 10, tetra-n-octyl polytitanate, which is a mixture of compounds of Formula (I) where m is within a range of 2 to 10, condensation products of tetraalkoxytitanium obtained by reaction of tetraalkoxytitanium with a small amount of water, and combinations of two or more of the foregoing.

The titanium compound (b) is preferably a titanium compound represented by Formula (I) where m is 1, 2 or 4, and more preferably is tetra-n-butoxytitanium, tetra-n-butoxytitanium dimer or tetra-n-butoxytitanium tetramer.

The organomagnesium compound (c) is a compound having a magnesium atom-carbon atom bond. Examples of the organomagnesium compound include compounds represented by Formula (iv) or (v):

R¹⁵MgX³ (iv)

R¹⁶R¹⁷Mg (v)

where each of R¹⁵, R¹⁶ and R¹⁷ is independently a hydrocarbyl group having 1 to 20 carbon atoms, and X³ is a halogen atom.

Grignard compounds represented by Formula (iv) are preferable for obtaining a catalyst in a favorable morphology, and ether solutions of Grignard compounds are particularly preferable.

Examples of the hydrocarbyl group having 1 to 20 carbon atoms for R¹⁵, R¹⁶ and R¹⁷ include alkyl groups, aryl groups, aralkyl groups and alkenyl groups, each having 1 to 20 carbon atoms, such as a methyl group, an ethyl group, a n-propyl group, an isopropyl group, a n-butyl group, a sec-butyl group, a tert-butyl group, an isopentyl group, a n-hexyl group, a n-octyl group, a 2-ethylhexyl group, a phenyl group, an allyl group and a benzyl group.

In Formulae (iv) and (v), each of R¹⁵, R¹⁶ and R¹⁷ is preferably an alkyl group having 2 to 18 carbon atoms or an aryl group having 6 to 18 carbon atoms, and particularly preferably an alkyl group having 2 to 18 carbon atoms.

Examples of X³ in Formula (Iv) include a chlorine atom, a bromine atom, and an iodine atom. A chlorine atom is particularly preferable.

Examples of the Grignard compound represented by Formula (iv) include methyl magnesium chloride, ethyl magnesium chloride, n-propyl magnesium chloride, isopropyl magnesium chloride, n-butyl magnesium chloride, isobutyl magnesium chloride, tert-butyl magnesium chloride, n-pentyl magnesium chloride, isopentyl magnesium chloride, cyclopentyl magnesium chloride, n-hexyl magnesium chloride, cyclohexyl magnesium chloride, n-octyl magnesium chloride, 2-ethylhexyl magnesium chloride, phenyl magnesium chloride, and benzyl magnesium chloride. Ethyl magnesium chloride, n-propyl magnesium chloride, isopropyl magnesium chloride, n-butyl magnesium chloride, and isobutyl magnesium chloride are preferable, and n-butyl magnesium chloride is particularly preferable.

Such Grignard compounds are preferably used in the form of a solution in an ether. Examples of the ether include dialkyl ethers such as diethyl ether, di-n-propyl ether, diisopropyl ether, di-n-butyl ether, diisobutyl ether, ethyl n-butyl ether and diisopentyl ether; and cyclic ethers such as tetrahydrofuran. Dialkyl ethers are preferable, and di-n-butyl ether and diisobutyl ether are particularly preferable.

In step (1), an ester compound (d) may be added.

Examples of ester compounds, which can be used as the ester compound (d) include carboxylic acid esters and polycarboxylic acid esters. Specific examples of the carboxylic acid esters include saturated aliphatic carboxylic acid esters, unsaturated aliphatic caroboxylic acid esters, alicyclic caroboxylic acid esters, and aromatic caroboxylic acid esters. More specifically, examples of the carboxylic acid esters include methyl acetate, ethyl acetate, phenyl acetate, methyl propionate, ethyl propionate, ethyl butyrate, ethyl valerate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, monoethyl phthalate, dimethyl phthalate, methylethyl phthalate, diethyl phthalate, di-n-propyl phthalate, diisopropyl phthalate, di-n-butyl phthalate, diisobutyl phthalate, dipentyl phthalate, di-n-hexyl phthalate, di-n-heptyl phthalate, di-n-octyl phthalate, bis(2-ethylhexyl)phthalate, diisodecyl phthalate, dicyclohexyl phthalate, and diphenyl phthalate. Aliphatic dicarboxylic acid diesters, aromatic caroboxylic acid esters such as ethyl benzoate and butyl benzoate, and aromatic dicarboxylic acid diesters such as phthalic acid esters are preferable.

In step (1), a solvent may be used. Examples of the solvent include aliphatic hydrocarbon compounds such as hexane, heptane, octane and decane; aromatic hydrocarbon compounds such as toluene and xylene; alicyclic hydrocarbon compounds such as cyclohexane, methyl cyclohexane and decalin; dialkyl ethers such as diethyl ether, di-n-propyl ether, diisopropyl ether, di-n-butyl ether, diisobutyl ether, ethyl n-butyl ether and diisopentyl ether, and cyclic ethers such as tetrahydrofuran; halogenated hydrocarbons such as dichloromethane, 1,2-dichloroethane, perfluorooctane, chlorobenzene, dichlorobenzene, trifluoromethyl benzene, chloromethyl benzene and chlorocyclohexane; and combinations thereof. Aliphatic hydrocarbon compounds, aromatic hydrocarbon compounds and alicyclic hydrocarbon compounds are preferable; aliphatic hydrocarbon compounds and alicyclic hydrocarbon compounds are more preferable; aliphatic hydrocarbon compound are further preferable; and hexane and heptane are particularly preferable.

In step (1), the silicon compound containing a Si—O bond (a) is used in such an amount that the amount of silicon may be usually from 1 mol to 500 mol, preferably from 1 mol to 300 mol, more preferably from 3 mol to 100 mol per mole of the total titanium atoms in the titanium compound (b) to be used.

In step (1), the organomagnesium compound (c) is used in such an amount that the total amount of the titanium atoms and the silicon atoms may be usually from 0.1 mol to 10 mol, preferably from 0.2 mol to 5.0 mol, particularly preferably from 0.5 mol to 2.0 mol per mole of the total magnesium atoms in the organomagnesium compound (c) to be used.

In step (1), the amounts of the titanium compound (b), the silicon compound containing a Si—O bond (a), and the organomagnesium compound (c) may also be determined so that the amount of the magnesium atoms in the precursor of the solid catalyst component to be obtained may be from 1 mol to 51 mol, preferably from 2 mol to 31 mol, particularly preferably from 4 mol to 26 mol per mole of the titanium atoms in the precursor.

In step (1), the ester compound (d) is used in an amount of usually from 0.05 mol to 100 mol, preferably from 0.1 mol to 60 mol, particularly preferably from 0.2 mol to 30 mol per mole of the total titanium atoms in the titanium compound to be used.

In step (1), the organomagnesium compound (c) is added to the solution containing the silicon compound containing a Si—O bond (a), the titanium compound (b) and the solvent at a temperature of usually −50° C. to 100° C., preferably −30° C. to 70° C., particularly preferably −25° C. to 50° C. The time during which the organomagnesium compound (c) is added is not particularly limited, and it is usually from about 30 minutes to about 6 hours. For obtaining a catalyst in a favorable morphology, continuous addition of the organomagnesium compound (c) is preferable. In order to further advance the reaction of the silicon compound containing a Si—O bond (a), the titanium compound (b) and the organomagnesium compound (c), these compounds may be made to react continuously at 5° C. to 120° C. for 30 minutes to 6 hours.

In step (1), a supporting material may be added to the reaction system to support the precursor of the solid catalyst component thereon. Examples of the supporting material include porous bodies of inorganic oxides such as SiO₂, Al₂O₃, MgO, TiO₂, and ZrO₂; and porous bodies of organic polymers such as polystyrene, a styrene-divinylbenzene copolymer, a styrene-ethylene glycol-dimethacrylic acid copolymer, poly (methyl acrylate), poly (ethyl acrylate), a methyl acrylate-divinylbenzene copolymer, poly (methyl methacrylate), a methyl methacrylate-divinylbenzene copolymer, polyacrylonitrile, an acrylonitrile-divinylbenzene copolymer, polyvinyl chloride, polyethylene and polypropylene. The porous organic polymers are preferable, and a styrene-divinylbenzene copolymer is particularly preferable.

In order to effectively fix the precursor of the solid catalyst component on a supporting material, the supporting material has pores of from 20 to 200 nm in radius in a pore volume of preferably 0.3 cm³/g or more, and more preferably 0.4 cm³/g or more, and the pore volume of the pores of from 20 to 200 nm preferably account for 35% or more, more preferably 40% or more of the pore volume of pores of from 3.5 to 7500 nm in radius.

When the silicon compound containing a Si—O bond (a), the titanium compound (b) represented by Formula (I), the organomagnesium compound (c), and, optionally, the ester compound (d) have been mixed, a reduction reaction of the titanium compound by the organomagnesium compound proceeds and, as a result, the tetravalent titanium atom of the titanium compound is reduced to a trivalent atom. In the present invention, it is preferable that substantially all of the tetravalent titanium atoms be reduced to trivalent atoms. The obtained precursor of the solid catalyst component contains trivalent titanium atoms, magnesium atoms and hydrocarbyloxy groups, and generally has amorphousness or very weak crystallinity, and preferably has an amorphous structure.

The obtained precursor of the solid catalyst component may be washed with a solvent. Examples of the solvent include aliphatic hydrocarbons such as pentane, hexane, heptane, octane and decane; aromatic hydrocarbons such as benzene, toluene, ethyl benzene and xylene; alicyclic hydrocarbons such as cyclohexane and cyclopentane; and halogenated hydrocarbons such as 1,2-dichloroethane and monochlorobenzene. Aliphatic hydrocarbons and aromatic hydrocarbons are preferable, aromatic hydrocarbons are more preferable, and toluene and xylene are particularly preferable.

The process of the present invention for producing a solid catalyst component (A) includes step (2) of producing a solid catalyst component (A) by bringing the precursor of the solid catalyst component, a halogenated metal compound represented by Formula (II) and an internal electron donor represented by Formula (III) into contact with each other,

MX²_{b}(R²)_{m-b} (II)

where M is a Group 4 element, a Group 13 element or a Group 14 element; R² is an alkyl group, an aryl group, an alkoxy group or an aryloxy group each having 1 to 20 carbon atoms; X² is a halogen atom; m is the valency of M; and b is an integer number satisfying 0<b≦m,

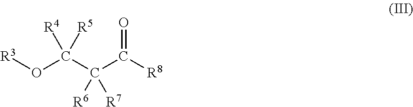

where R³ is a hydrocarbyl group having 1 to 20 carbon atoms; R⁴, R⁵, R⁶ and R⁷ are each independently a hydrogen atom, a halogen atom or a hydrocarbyl group having 1 to 20 carbon atoms; and R⁸ is a halogen atom or a hydrocarbyloxy group having 1 to 20 carbon atoms.

In Formula (III), it is preferable that at lease one group selected from R⁴, R⁵, R⁶ and R⁷ be a hydrocarbyl group having 1 to 20 carbon atoms.

Examples of the Group 4 element for M in Formula (II) include titanium, zirconium and hafnium. Titanium is preferable. Examples of the Group 13 element for M include boron, aluminum, gallium, indium and thallium. Boron and aluminum are preferable, and aluminum is more preferable. Examples of the Group 14 element for M include silicon, germanium, tin and lead. Silicon, germanium and tin are preferable, and silicon is more preferable.

Examples of the hydrocarbyl group for R² include linear or branched alkyl groups such as a methyl group, an ethyl group, a n-propyl group, an isopropyl group, a n-butyl group, an isobutyl group, a n-pentyl group, an isopentyl group, a hexyl group, a heptyl group, an octyl group, a decyl group and a dodecyl group; cyclic alkyl groups such as a cyclohexyl group and a cyclopentyl group; aryl groups such as a phenyl group, a tolyl group, a xylyl group and a naphthyl group.

Examples of the hydrocarbyloxy group for R² include linear or branched alkoxy groups such as a methoxy group, an ethoxy group, a n-propoxy group, an isopropoxy group, a n-butoxy group, an isobutoxy group, a n-amyloxy group, an isoamyloxy group, a hexyloxy group, a heptyloxy group, an octyloxy group, a decyloxy group and a dodecyloxy group; cyclic alkoxy groups such as a cyclohexyloxy group and a cyclopentyloxy group; and aryloxy groups such as a phenoxy group, a xyloxy group and a naphthoxy group.

R² is preferably an alkyl group or an alkoxy group each having 2 to 18 carbon atoms, and an aryl group or an aryloxy group each having 6 to 18 carbon atoms are preferable.

In Formula (II), examples of X² include a fluorine atom, a chlorine atom, a bromine atom and an iodine atom, and a chlorine atom and a bromine atom are preferable, and a chlorine atom is more preferable.

In Formula (II), m is the valency of M. When M is a Group 4 element, m is 4; when M is a Group 13 element, m is 3; and when M is a Group 14 element, m is 4.

In Formula (II), b is an integer number satisfying 0<b≦m. When M is a Group 4 element or a Group 14 element, b is an integer number satisfying 0<b≦4; and when M is a Group 13 element, b is an integer number satisfying 0<b≦3. When M is a Group 4 element or a Group 14 element, b is preferably 3 or 4, more preferably 4. When M is a Group 13 element, b is preferably 3.

The halogenated titanium compound as the halogenated metal compound represented by Formula (II) is preferably a titanium tetrahalide such as titanium tetrachloride, titanium tetrabromide or titanium tetraiodide; or an alkoxy titanium trihalide such as methoxytitanium trichloride, ethoxytitanium trichloride, butoxytitanium trichloride, phenoxytitanium trichloride or ethoxytitanium tribromide, more preferably a titanium tetrahalide, particularly preferably titanium tetrachloride.

The chlorinated compound of the Group 13 element or the chlorinated compound of the Group 14 element as the halogenated metal compound represented by Formula (II) are preferably ethyl aluminum dichloride, ethyl aluminum sesquichloride, diethyl aluminum chloride, trichloroaluminum, tetrachlorosilane, phenyl trichlorosilane, methyl trichlorosilane, ethyl trichlorosilane, n-propyl trichlorosilane or para-tolyl trichlorosilane, more preferably the chlorinated compound of the Group 14 element, particularly preferably tetrachlorosilane and phenyl trichlorosilane.

Examples of the hydrocarbyl group as R³ in Formula (III) include an alkyl group, an aralkyl group, an aryl group, and an alkenyl group, wherein a part or all of hydrogen atoms contained in these groups may be substituted by a halogen atom, a hydrocarbyloxy group, a nitro group, a sulfonyl group, a silyl group, or the like. Examples of the alkyl group as R³ include linear alkyl groups such as a methyl group, an ethyl group, a n-propyl group, a n-butyl group, a n-pentyl group, a n-hexyl group, a n-heptyl group and a n-octyl group; branched alkyl groups such as an isopropyl group, an isobutyl group, a tert-butyl group, an isopentyl group, a neopentyl group and a 2-ethylhexyl group; and cyclic alkyl groups such as a cyclopropyl group, a cyclobutyl group, a cyclopentyl group, a cyclohexyl group, a cycloheptyl group and a cyclooctyl group. The alkyl group is preferably a linear, branched or cyclic alkyl group having 1 to 20 carbon atoms; more preferably a linear or branched alkyl group having 1 to 20 carbon atoms. Examples of the aralkyl group for R³ include a benzyl group and a phenethyl group, and an aralkyl group having 7 to 20 carbon atoms is preferable. Examples of the aryl group for R³ include a phenyl group, a tolyl group and a xylyl group, and an aryl group having 6 to 20 carbon atom is preferable. Examples of the alkenyl group for R³ include linear alkenyl groups such as a vinyl group, an allyl group, a 3-butenyl group and a 5-hexenyl group; branched alkenyl groups such as an isobutenyl group and a 5-methyl-3-pentenyl group; and cyclic alkenyl groups such as a 2-cyclohexenyl group and a 3-cyclohexenyl group, and an alkenyl group having 2 to 20 carbon atoms is preferable.

R³ in Formula (III) is preferably an alkyl group having 1 to 20 carbon atoms. A linear or branched alkyl group having 1 to 20 carbon atoms is more preferable, and a methyl group, an ethyl group, a n-propyl group, a n-butyl group, a n-pentyl group, a n-hexyl group, a n-heptyl group, a n-octyl group, an isopropyl group, an isobutyl group, a tert-butyl group, an isopentyl group, a neopentyl group and a 2-ethylhexyl group are further preferable, and a methyl group and an ethyl group are the most preferable.

Examples of the halogen atom as R⁴ to R⁷ in Formula (III) include a fluorine atom, a chlorine atom, a bromine atom and an iodine atom, and a fluorine atom, a chlorine atom and a bromine atom are preferable.

Examples of the hydrocarbyl group as R⁴ to R⁷ in Formula (III) include alkyl groups, aralkyl groups, aryl groups, and alkenyl groups, wherein a part or all of hydrogen atoms contained in these groups may be substituted by a halogen atom, a hydrocarbyloxy group, a nitro group, a sulfonyl group, a silyl group, or the like.

Examples of the alkyl group as R⁴ to R⁷ include linear alkyl groups such as a methyl group, an ethyl group, a n-propyl group, a n-butyl group, a n-pentyl group, a n-hexyl group, a n-heptyl group and a n-octyl group; branched alkyl groups such as an isopropyl group, an isobutyl group, a tert-butyl group, an isopentyl group, a neopentyl group, a 2-ethylhexyl group, a 1,1-dimethyl-2-methylpropyl group, a 1,1-dimethyl-2,2-dimethylpropyl group, a 1,1-dimethyl-n-butyl group, a 1,1-dimethyl-n-pentyl group and a 1,1-dimethyl-n-hexyl group; and cyclic alkyl groups such as a cyclopropyl group, a cyclobutyl group, a cyclopentyl group, a cyclohexyl group, a cycloheptyl group and a cyclooctyl group. The alkyl group is preferably a linear, branched or cyclic alkyl group having 1 to 20 carbon atoms. Examples of the aralkyl group as R⁴ to R⁷ include a benzyl group and a phenethyl group, and aralkyl groups having 7 to 20 carbon atoms are preferable. Examples of the aryl group as R⁴ to R⁷ include a phenyl group, a tolyl group and a xylyl group, and an aryl group having 6 to 20 carbon atoms is preferable. Examples of the alkenyl group as R⁴ to R⁷ include linear alkenyl groups such as a vinyl group, an allyl group, a 3-butenyl group and a 5-hexenyl group; branched alkenyl groups such as an isobutenyl group and a 5-methyl-3-pentenyl group; and cyclic alkenyl groups such as a 2-cyclohexenyl group and a 3-cyclohexenyl group, and an alkenyl group having 2 to 10 carbon atoms is preferable.

R⁶ in Formula (III) is preferably an alkyl group having 1 to 20 carbon atoms or an aryl group having 6 to 20 carbon atoms, and a branched or cyclic alkyl group having 3 to 20 carbon atoms, and an aryl group having 6 to 20 carbon atoms are more preferable, a branched alkyl group such as an isopropyl group, an isobutyl group, a tert-butyl group, an isopentyl group, a neopentyl group, a 2-ethylhexyl group, a 1,1-dimethyl-2-methylpropyl group, a 1,1-dimethyl-2,2-dimethylpropyl group, a 1,1-dimethyl-n-butyl group, a 1,1-dimethyl-n-pentyl group and a 1,1-dimethyl-n-hexyl group; a cyclic alkyl group such as a cyclopropyl group, a cyclobutyl group, a cyclopentyl group, a cyclohexyl group, a cycloheptyl group and a cyclooctyl group; and an aryl group such as a phenyl group, an o-tolyl group, an m-tolyl group, a p-tolyl group, a 2,6-dimethylphenyl group, a 2,4,6-trimethylphenyl group, an o-ethylphenyl group, an m-ethylphenyl group, a p-ethylphenyl group, a 2,6-diethylphenyl group, a 2,4,6-triethylphenyl group, a m-normal-propylphenyl group and a m-isopropylphenyl group are further preferable, and a branched alkyl group such as an isopropyl group, an isobutyl group, a tert-butyl group, an isopentyl group, a neopentyl group, a 2-ethylhexyl group, a 1,1-dimethyl-2-methylpropyl group, a 1,1-dimethyl-2,2-dimethylpropyl group, a 1,1-dimethyl-n-butyl group, a 1,1-dimethyl-n-pentyl group and a 1,1-dimethyl-n-hexyl group; and an aryl group such as a phenyl group are particularly preferable.

R⁷ in Formula (III) is preferably a hydrogen atom, an alkyl group having 1 to 20 carbon atoms and an aryl group having 6 to 20 carbon atoms, and a hydrogen atom, a linear or branched alkyl group having 1 to 20 carbon atoms, or an aryl group having 6 to 20 carbon atoms are more preferable, a hydrogen atom, a linear alkyl group such as a methyl group, an ethyl group, a n-propyl group, a n-butyl group, a n-pentyl group, a n-hexyl group, a n-heptyl group and a n-octyl group; a branched alkyl group such as an isopropyl group, an isobutyl group, a tert-butyl group, an isopentyl group, a neopentyl group, a 2-ethylhexyl group, a 1,1-dimethyl-2-methylpropyl group, a 1,1-dimethyl-2,2-dimethylpropyl group, a 1,1-dimethyl-n-butyl group, a 1,1-dimethyl-n-pentyl group and a 1,1-dimethyl-n-hexyl group; and an aryl group such as a phenyl group, an o-tolyl group, an m-tolyl group, a p-tolyl group, a 2,6-dimethylphenyl group, a 2,4,6-trimethylphenyl group, an o-ethylphenyl group, a m-ethylphenyl group, a p-ethylphenyl group, a 2,6-diethylphenyl group, a 2,4,6-triethylphenyl group, a 3-propylphenyl group and a 3-isopropylphenyl group are further preferable, a hydrogen atom, and a linear alkyl group having 1 to 10 carbon atoms such as a methyl group, an ethyl group, a n-propyl group, a n-butyl group, a n-pentyl group, a n-hexyl group, a n-heptyl group and a n-octyl group are particularly preferable, and a hydrogen atom, a methyl group, an ethyl group, a n-propyl group, a n-butyl group and a n-pentyl group are most preferable.

R⁴ and R⁵ in Formula (III) is each preferably a hydrogen atom and an alkyl group having 1 to 10 carbon atoms, and a hydrogen atom and a linear alkyl group having 1 to 10 carbon atoms are more preferable, a hydrogen atom, a methyl group, an ethyl group, a n-propyl group, a n-butyl group and a n-pentyl group are particularly preferable, and a hydrogen atom is most preferable.

In Formula (III), examples of the halogen atom as R⁸ include a fluorine atom, a chlorine atom, a bromine atom and an iodine atom. As R⁸, a fluorine atom, a chlorine atom and a bromine atom are preferable, and a chlorine atom is more preferable.

In Formula (III), examples of the hydrocarbyloxy group as R⁸ include an alkoxy group, an aralkyloxy group, an aryloxy group, and an alkenyloxy group, wherein a part or all of the hydrogen atoms contained in these groups may be substituted by a halogen atom, a nitro group, a sulfonyl group, a silyl group, or the like. Examples of the alkoxy group for R⁸ include linear alkoxy groups such as a methoxy group, an ethoxy group, a n-propoxy group, a n-butoxy group, a n-pentoxy group, a n-hexoxy group, a n-heptoxy group, a n-octoxy group and n-decoxy group; branched alkoxy groups such as an isopropoxy group, an isobutoxy group, a tert-butoxy group, an isopentoxy group, a neopentoxy group, an isoamyloxy group and a 2-ethylhexyloxy group; and cyclic alkoxy groups such as a cyclopropyloxy group, a cyclobutyloxy group, a cyclopentyloxy group, a cyclohexyloxy group, a cycloheptyloxy group and a cyclooctyloxy group. Linear or branched alkoxy groups having 1 to 10 carbon atoms are preferable. Examples of the aralkyloxy group for R⁸ include a benzyloxy group and a phenethyloxy group, and aralkyloxy groups having 7 to 10 carbon atoms are preferable. Examples of the aryloxy group for R⁸ include a phenoxy group, a methylphenoxy group and a mesityloxy group, and aryloxy groups having 6 to 10 carbon atoms are preferable. Examples of the alkenyloxy group for R⁸ include linear alkenyloxy groups such as a vinyloxy group, an allyloxy group, a 3-butenyloxy group and a 5-hexenyloxy group; branched alkenyloxy groups such as an isobutenyloxy group and a 4-methyl-3-pentenyloxy group; and cyclic alkenyloxy groups such as a 2-cyclohexenyloxy group and a 3-cyclohexenyloxy group. Linear or branched alkenyloxy groups having 2 to 10 carbon atoms are preferable.

Specific examples of the internal electron doner of Formula (III) include ethyl 3-ethoxy-2-isopropylpropionate, ethyl 3-ethoxy-2-isobutylpropionate, ethyl 3-ethoxy-2-tert-butylpropionate, ethyl 3-ethoxy-2-tert-amylpropionate, ethyl 3-ethoxy-2-cyclohexylpropionate, ethyl 3-ethoxy-2-cyclopentylpropionate, ethyl 3-ethoxy-2-adamantylpropionate, ethyl 3-ethoxy-2-phenylpropionate, ethyl 3-ethoxy-2-(2,3-dimethyl-2-butyl)propionate, ethyl 3-ethoxy-2-(2,3,3-trimethyl-2-butyl)propionate, ethyl 3-ethoxy-2-(2-methyl-2-hexyl)propionate, ethyl 3-isobutoxy-2-isopropylpropionate, ethyl 3-isobutoxy-2-isobutylpropionate, ethyl 3-isobutoxy-2-tert-butylpropionate, ethyl 3-isobutoxy-2-tert-amylpropionate, ethyl 3-isobutoxy-2-cyclohexylpropionate, ethyl 3-isobutoxy-2-cyclopentylpropionate, ethyl 3-isobutoxy-2-adamantylpropionate, ethyl 3-isobutoxy-2-phenylpropionate, ethyl 3-methoxy-2-isopropylpropionate, ethyl 3-methoxy-2-isobutylpropionate, ethyl 3-methoxy-2-tert-butylpropionate, ethyl 3-methoxy-2-tert-amylpropionate, ethyl 3-methoxy-2-cyclohexylpropionate, ethyl 3-methoxy-2-cyclopentylpropionate, ethyl 3-methoxy-2-adamantylpropionate, ethyl 3-methoxy-2-phenylpropionate, ethyl 3-methoxy-2-(2,3-dimethyl-2-butyl)propionate, ethyl 3-methoxy-2-(2,3,3-trimethyl-2-butyl)propionate, ethyl 3-methoxy-2-(2-methyl-2-hexyl)propionate, methyl 3-ethoxy-2-isopropylpropionate, methyl 3-ethoxy-2-isobutylpropionate, methyl 3-ethoxy-2-tert-butylpropionate, methyl 3-ethoxy-2-tert-amylpropionate, methyl 3-ethoxy-2-cyclohexylpropionate, methyl 3-ethoxy-2-cyclopentylpropionate, methyl 3-ethoxy-2-adamantylpropionate, methyl 3-ethoxy-2-phenylpropionate, methyl 3-ethoxy-2-(2,3-dimethyl-2-butyl)propionate, methyl 3-ethoxy-2-(2,3,3-trimethyl-2-butyl)propionate, methyl 3-ethoxy-2-(2-methyl-2-hexyl)propionate, methyl 3-methoxy-2-isopropylpropionate, methyl 3-methoxy-2-isobutylpropionate, methyl 3-methoxy-2-tert-butylpropionate, methyl 3-methoxy-2-tert-amylpropionate, methyl 3-methoxy-2-cyclohexylpropionate, methyl 3-methoxy-2-cyclopentylpropionate, methyl 3-methoxy-2-adamantylpropionate, methyl 3-methoxy-2-phenylpropionate, methyl 3-methoxy-2-(2,3-dimethyl-2-butyl)propionate, methyl 3-methoxy-2-(2,3,3-trimethyl-2-butyl)propionate, methyl 3-methoxy-2-(2-methyl-2-hexyl)propionate, ethyl 3-ethoxy-3-isopropyl-2-isobutylpropionate, ethyl 3-ethoxy-3-isobutyl-2-isobutylpropionate, ethyl 3-ethoxy-3-isobutyl-2-tert-butylpropionate, ethyl 3-ethoxy-2,3-di-tert-butylpropionate, ethyl 3-ethoxy-3-isobutyl-2-tert-amylpropionate, ethyl 3-ethoxy-3-tert-butyl-2-tert-amylpropionate, ethyl 3-ethoxy-2,3-di-tert-amylpropionate, ethyl 3-ethoxy-3-isobutyl-2-cyclohexyl propionate, ethyl 3-ethoxy-2,3-dicyclohexylpropionate, ethyl 3-ethoxy-3-isobutyl-2-cyclopentylpropionate, ethyl 3-ethoxy-2,3-dicyclopentylpropionate, ethyl 3-ethoxy-2,3-diphenylpropionate, ethyl 3-methoxy-2,2-diisopropyl propionate, methyl 3-methoxy-2,2-diisopropylpropionate, ethyl 3-ethoxy-2,2-diisopropyl propionate, methyl 3-ethoxy-2,2-diisopropylpropionate, ethyl 3-ethoxy-2,2-diphenyl propionate, methyl 3-ethoxy-2,2-diphenylpropionate, methyl 3-methoxy-2-isopropyl-2-isobutylpropionate, ethyl 3-methoxy-2-isopropyl-2-isobutylpropionate, ethyl 3-ethoxy-2-isopropyl-2-isobutylpropionate, methyl 3-methoxy-2-isopropyl-2-tert-butylpropionate, ethyl 3-methoxy-2-isopropyl-2-tert-butylpropionate, ethyl 3-ethoxy-2-isopropyl-2-tert-butylpropionate, methyl 3-methoxy-2-isopropyl-2-tert-amylpropionate, ethyl 3-methoxy-2-isopropyl-2-tert-amylpropionate, ethyl 3-ethoxy-2-isopropyl-2-tert-amylpropionate, methyl 3-methoxy-2-isopropyl-2-cyclopentylpropionate, ethyl 3-methoxy-2-isopropyl-2-cyclopentylpropionate, ethyl 3-ethoxy-2-isopropyl-2-cyclopentylpropionate, methyl 3-methoxy-2-isopropyl-2-cyclohexylpropionate, ethyl 3-methoxy-2-isopropyl-2-cyclohexylpropionate, ethyl 3-ethoxy-2-isopropyl-2-cyclohexylpropionate, methyl 3-methoxy-2-isopropyl-2-phenylpropionate, ethyl 3-methoxy-2-isopropyl-2-phenylpropionate, ethyl 3-ethoxy-2-isopropyl-2-phenylpropionate, ethyl 3-methoxy-2,2-diisobutylpropionate, methyl 3-methoxy-2,2-diisobutylpropionate, ethyl 3-ethoxy-2,2-diisobutylpropionate, methyl 3-ethoxy-2,2-diisobutylpropionate, methyl 3-methoxy-2-isobutyl-2-tert-butylpropionate, ethyl 3-methoxy-2-isobutyl-2-tert-butylpropionate, ethyl 3-ethoxy-2-isobutyl-2-tert-butylpropionate, methyl 3-methoxy-2-isobutyl-2-tert-amylpropionate, ethyl 3-methoxy-2-isobutyl-2-tert-amylpropionate, ethyl 3-ethoxy-2-isobutyl-2-tert-amylpropionate, methyl 3-methoxy-2-isobutyl-2-cyclopentylpropionate, ethyl 3-methoxy-2-isobutyl-2-cyclopentylpropionate, ethyl 3-ethoxy-2-isobutyl-2-cyclopentylpropionate, methyl 3-methoxy-2-isobutyl-2-cyclohexylpropionate, ethyl 3-methoxy-2-isobutyl-2-cyclohexylpropionate, ethyl 3-ethoxy-2-isobutyl-2-cyclohexylpropionate, methyl 3-methoxy-2-isobutyl-2-phenylpropionate, ethyl 3-methoxy-2-isobutyl-2-phenylpropionate, ethyl 3-ethoxy-2-isobutyl-2-phenylpropionate, ethyl 3-methoxy-2,2-di-tert-butylpropionate, methyl 3-methoxy-2,2-di-tert-butylpropionate, ethyl 3-ethoxy-2,2-di-tert-butylpropionate, methyl 3-ethoxy-2,2-di-tert-butylpropionate, methyl 3-methoxy-2-tert-butyl-2-methylpropionate, ethyl 3-methoxy-2-tert-butyl-2-methylpropionate, ethyl 3-ethoxy-2-tert-butyl-2-methylpropionate, methyl 3-methoxy-2-tert-butyl-2-ethylpropionate, ethyl 3-methoxy-2-tert-butyl-2-ethylpropionate, ethyl 3-ethoxy-2-tert-butyl-2-ethylpropionate, methyl 3-methoxy-2-tert-butyl-2-n-propylpropionate, ethyl 3-methoxy-2-tert-butyl-2-n-propylpropionate, ethyl 3-ethoxy-2-tert-butyl-2-n-propylpropionate, methyl 3-methoxy-2-tert-butyl-2-n-butylpropionate, ethyl 3-methoxy-2-tert-butyl-2-n-butylpropionate, ethyl 3-ethoxy-2-tert-butyl-2-n-butylpropionate, methyl 3-methoxy-2-tert-butyl-2-n-pentylpropionate, ethyl 3-methoxy-2-tert-butyl-2-n-pentylpropionate, ethyl 3-ethoxy-2-tert-butyl-2-n-pentylpropionate, ethyl 3-ethoxy-2,2-dicyclohexylpropionate, ethyl 3-ethoxy-2,2-dicyclopentylpropionate, 3-ethoxy-2-isopropylpropionyl chloride, 3-ethoxy-2-tert-butylpropionyl chloride, 3-ethoxy-2-tert-amylpropionyl chloride, 3-ethoxy-2-cyclohexylpropionyl chloride, 3-ethoxy-2-cyclopentylpropionyl chloride, 3-ethoxy-2-adamantylpropionyl chloride, 3-ethoxy-2-phenylpropionyl chloride, 3-ethoxy-2-(2,3-dimethyl-2-butyl)propionyl chloride, 3-ethoxy-2-(2,3,3-trimethyl-2-butyl)propionyl chloride, 3-ethoxy-2-(2-methyl-2-hexyl)propionyl chloride, 3-isobutoxy-2-isopropylpropionyl chloride, 3-isobutoxy-2-isobutylpropionyl chloride, 3-isobutoxy-2-tert-butylpropionyl chloride, 3-isobutoxy-2-tert-amylpropionyl chloride, 3-isobutoxy-2-cyclohexylpropionyl chloride, 3-isobutoxy-2-cyclopentylpropionyl chloride, 3-isobutoxy-2-adamantylpropionyl chloride, 3-isobutoxy-2-phenylpropionyl chloride, 3-methoxy-2-isopropylpropionyl chloride, 3-methoxy-2-isobutylpropionyl chloride, 3-methoxy-2-tert-butylpropionyl chloride, 3-methoxy-2-tert-amylpropionyl chloride, 3-methoxy-2-cyclohexylpropionyl chloride, 3-methoxy-2-cyclopentylpropionyl chloride, 3-methoxy-2-adamantylpropionyl chloride, 3-methoxy-2-phenylpropionyl chloride, 3-methoxy-2-(2,3-dimethyl-2-butyl)propionyl chloride, 3-methoxy-2-(2,3,3-trimethyl-2-butyl)propionyl chloride, 3-methoxy-2-(2-methyl-2-hexyl)propionyl chloride, 3-ethoxy-3-isopropyl-2-isobutylpropionyl chloride, 3-ethoxy-3-isobutyl-2-isobutylpropionyl chloride, 3-ethoxy-3-isobutyl-2-tert-butylpropionyl chloride, 3-ethoxy-2,3-di-tert-butylpropionyl chloride, 3-ethoxy-3-isobutyl-2-tert-amylpropionyl chloride, 3-ethoxy-3-tert-butyl-2-tert-amylpropionyl chloride, 3-ethoxy-2,3-di-tert-amylpropionyl chloride, 3-ethoxy-3-isobutyl-2-cyclohexylpropionyl chloride, 3-ethoxy-2,3-dicyclohexylpropionyl chloride, 3-ethoxy-3-isobutyl-2-cyclopentylpropionyl chloride, 3-ethoxy-2,3-dicyclopentylpropionyl chloride, 3-methoxy-2,2-diisopropylpropionyl chloride, 3-ethoxy-2,2-diisopropylpropionyl chloride, 3-methoxy-2-isopropyl-2-isobutylpropionyl chloride, 3-ethoxy-2-isopropyl-2-isobutylpropionyl chloride, 3-methoxy-2-isopropyl-2-tert-butylpropionyl chloride, 3-ethoxy-2-isopropyl-2-tert-butylpropionyl chloride, 3-methoxy-2-isopropyl-2-tert-amylpropionyl chloride, 3-ethoxy-2-isopropyl-2-tert-amylpropionyl chloride, 3-methoxy-2-isopropyl-2-cyclopentylpropionyl chloride, 3-ethoxy-2-isopropyl-2-cyclopentylpropionyl chloride, 3-methoxy-2-isopropyl-2-cyclohexylpropionyl chloride, 3-ethoxy-2-isopropyl-2-cyclohexylpropionyl chloride, 3-methoxy-2-isopropyl-2-phenylpropionyl chloride, 3-ethoxy-2-isopropyl-2-phenylpropionyl chloride, 3-methoxy-2,2-diisobutylpropionyl chloride, 3-ethoxy-2,2-diisobutylpropionyl chloride, 3-methoxy-2-isobutyl-2-tert-butylpropionyl chloride, 3-ethoxy-2-isobutyl-2-tert-butylpropionyl chloride, 3-methoxy-2-isobutyl-2-tert-amylpropionyl chloride, 3-ethoxy-2-isobutyl-2-tert-amylpropionyl chloride, 3-methoxy-2-isobutyl-2-cyclopentylpropionyl chloride, 3-ethoxy-2-isobutyl-2-cyclopentylpropionyl chloride, 3-methoxy-2-isobutyl-2-cyclohexylpropionyl chloride, 3-ethoxy-2-isobutyl-2-cyclohexylpropionyl chloride, 3-methoxy-2-isobutyl-2-phenylpropionyl chloride, 3-ethoxy-2-isobutyl-2-phenylpropionyl chloride, 3-methoxy-2,2-di-tert-butylpropionyl chloride, 3-ethoxy-2,2-di-tert-butylpropionyl chloride, 3-methoxy-2-tert-butyl-2-methylpropionyl chloride, 3-ethoxy-2-tert-butyl-2-methylpropionyl chloride, 3-methoxy-2-tert-butyl-2-ethylpropionyl chloride, 3-ethoxy-2-tert-butyl-2-ethylpropionyl chloride, 3-methoxy-2-tert-butyl-2-n-propylpropionyl chloride, 3-ethoxy-2-tert-butyl-2-n-propylpropionyl chloride, 3-methoxy-2-tert-butyl-2-n-butylpropionyl chloride, 3-ethoxy-2-tert-butyl-2-n-butylpropionyl chloride, 3-methoxy-2-tert-butyl-2-n-pentylpropionyl chloride, 3-ethoxy-2-tert-butyl-2-n-pentylpropionyl chloride, 3-methoxy-2-tert-butyl-2-phenylpropionyl chloride, 3-ethoxy-2-tert-butyl-2-phenylpropionyl chloride, and 3-ethoxy-2,2-dicyclohexylpropionyl chloride.

Preferable are ethyl 3-ethoxy-2-tert-butylpropionate, ethyl 3-ethoxy-2-tert-amylpropionate, ethyl 3-ethoxy-2-cyclohexylpropionate, ethyl 3-ethoxy-2-cyclopentylpropionate, ethyl 3-ethoxy-2-phenylpropionate, ethyl 3-methoxy-2-phenylpropionate, methyl 3-ethoxy-2-phenylpropionate, methyl 3-methoxy-2-phenylpropionate, ethyl 3-ethoxy-2-(2,3-dimethyl-2-butyl)propionate, ethyl 3-ethoxy-2-(2,3,3-trimethyl-2-butyl)propionate, ethyl 3-ethoxy-2-(2-methyl-2-hexyl)propionate, ethyl 3-methoxy-2-tert-butylpropionate, methyl 3-ethoxy-2-tert-butylpropionate, methyl 3-methoxy-2-tert-butylpropionate, ethyl 3-ethoxy-3-isobutyl-2-tert-butylpropionate, ethyl 3-ethoxy-2,3-di-tert-butylpropionate, ethyl 3-ethoxy-3-tert-butyl-2-tert-amylpropionate, methyl 3-methoxy-2-isopropyl-2-tert-butylpropionate, ethyl 3-methoxy-2-isopropyl-2-tert-butylpropionate, ethyl 3-ethoxy-2-isopropyl-2-tert-butylpropionate, methyl 3-methoxy-2-isobutyl-2-tert-butylpropionate, ethyl 3-methoxy-2-isobutyl-2-tert-butylpropionate, ethyl 3-ethoxy-2-isobutyl-2-tert-butylpropionate, ethyl 3-methoxy-2,2-di-tert-butylpropionate, methyl 3-methoxy-2,2-di-tert-butylpropionate, ethyl 3-ethoxy-2,2-di-tert-butylpropionate, methyl 3-ethoxy-2,2-di-tert-butylpropionate, methyl 3-methoxy-2-tert-butyl-2-methylpropionate, ethyl 3-methoxy-2-tert-butyl-2-methylpropionate, ethyl 3-ethoxy-2-tert-butyl-2-methylpropionate, methyl 3-methoxy-2-tert-butyl-2-ethylpropionate, ethyl 3-methoxy-2-tert-butyl-2-ethylpropionate, ethyl 3-ethoxy-2-tert-butyl-2-ethylpropionate, methyl 3-methoxy-2-tert-butyl-2-n-propylpropionate, ethyl 3-methoxy-2-tert-butyl-2-n-propylpropionate, ethyl 3-ethoxy-2-tert-butyl-2-n-propylpropionate, methyl 3-methoxy-2-tert-butyl-2-n-butylpropionate, ethyl 3-methoxy-2-tert-butyl-2-n-butylpropionate, ethyl 3-ethoxy-2-tert-butyl-2-n-butylpropionate, methyl 3-methoxy-2-tert-butyl-2-n-pentylpropionate, ethyl 3-methoxy-2-tert-butyl-2-n-pentylpropionate, ethyl 3-ethoxy-2-tert-butyl-2-n-pentylpropionate, 3-ethoxy-2-tert-butylpropionyl chloride, 3-ethoxy-2-cyclohexylpropionyl chloride, 3-ethoxy-2-cyclopentylpropionyl chloride, 3-ethoxy-2-phenylpropionyl chloride, 3-methoxy-2-phenylpropionyl chloride, 3-ethoxy-2-(2,3-dimethyl-2-butyl)propionyl chloride, 3-ethoxy-2-(2,3,3-trimethyl-2-butyl)propionyl chloride, 3-ethoxy-2-(2-methyl-2-hexyl)propionyl chloride, 3-methoxy-2-tert-butylpropionyl chloride, 3-ethoxy-3-isobutyl-2-tert-butylpropionyl chloride, 3-ethoxy-2,3-di-tert-butylpropionyl chloride, 3-ethoxy-3-tert-butyl-2-tert-amylpropionyl chloride, 3-methoxy-2-isopropyl-2-tert-butylpropionyl chloride, 3-ethoxy-2-isopropyl-2-tert-butylpropionyl chloride, 3-methoxy-2-isobutyl-2-tert-butylpropionyl chloride, 3-ethoxy-2-isobutyl-2-tert-butylpropionyl chloride, 3-methoxy-2,2-di-tert-butylpropionyl chloride, 3-ethoxy-2,2-di-tert-butylpropionyl chloride, 3-methoxy-2-tert-butyl-2-methylpropionyl chloride, 3-ethoxy-2-tert-butyl-2-methylpropionyl chloride, 3-methoxy-2-tert-butyl-2-ethylpropionyl chloride, 3-ethoxy-2-tert-butyl-2-ethylpropionyl chloride, 3-methoxy-2-tert-butyl-2-n-propylpropionyl chloride, 3-ethoxy-2-tert-butyl-2-n-propylpropionyl chloride, 3-methoxy-2-tert-butyl-2-n-butylpropionyl chloride, 3-ethoxy-2-tert-butyl-2-n-butylpropionyl chloride, 3-methoxy-2-tert-butyl-2-n-pentylpropionyl chloride, and 3-ethoxy-2-tert-butyl-2-n-pentylpropionyl chloride; and particularly preferable are ethyl 3-ethoxy-2-tert-butylpropionate, ethyl 3-ethoxy-2-phenylpropionate, ethyl 3-ethoxy-2-(2,3-dimethyl-2-butyl)propionate, ethyl 3-ethoxy-2-(2,3,3-trimethyl-2-butyl)propionate, ethyl 3-ethoxy-2-(2-methyl-2-hexyl)propionate, 3-ethoxy-2-tert-butyl propionyl chloride, 3-ethoxy-2-phenylpropionyl chloride, 3-ethoxy-2-(2,3-dimethyl-2-butyl)propionyl chloride, 3-ethoxy-2-(2,3,3-trimethyl-2-butyl)propionyl chloride, 3-ethoxy-2-(2-methyl-2-hexyl)propionyl chloride.

The halogenated metal compound represented by Formula (II) is used usually in an amount of from 0.1 mmol to 1000 mmol, preferably from 1 mmol to 100 mmol, particularly preferably from 7 mmol to 30 mmol per gram of the precursor of the solid catalyst component. The halogenated metal compound is added at once or in multiple batches.

The internal electron donor represented by Formula (III) is used usually in an amount of from 0.01 ml to 10 ml, preferably from 0.03 ml to 5 ml, particularly preferably from 0.05 ml to 1 ml per gram of the precursor of the solid catalyst component. The internal electron donor represented by Formula (III) is added at once or in multiple batches.

The time during which the precursor of the solid catalyst component, the internal electron donor represented by Formula (III), and the halogenated metal compound represented by Formula (II) are brought into contact with each other is usually from 10 minutes to 12 hours, preferably from 30 minutes to 10 hours, particularly preferably from 1 hour to 8 hours.

The temperature at which they are brought into contact with each other is usually within a range of −50° C. to 200° C., preferably 0° C. to 170° C., more preferably 50° C. to 150° C., particularly preferably 50° C. to 120° C.

The contact in step (2) is usually wholly performed under an atmosphere of an inert gas such as a nitrogen gas or an argon gas. Any of the following processes may be used as the step (2) of producing the solid catalyst component (A) by bringing the precursor of the solid catalyst component, the halogenated metal compound represented by Formula (II) (hereinafter may be referred to as the “halogenated metal compound (II)”) and the internal electron donor represented by Formula (III) (hereinafter may be referred to as the “internal electron donor (III)”) into contact with each other:

(2-1) a process in which the halogenated metal compound (II) and the internal electron donor (III) are added to the precursor of the solid catalyst component in an arbitrary order to produce a solid component;
(2-2) a process in which a mixture of the halogenated metal compound (II) and the internal electron donor (III) is added to the precursor of the solid catalyst component to produce a solid component;
(2-3) a process in which the internal electron donor (III) is added to the precursor of the solid catalyst component, and further the halogenated metal compound (II) is added to produce a solid component;
(2-4) a process in which the internal electron donor (III) is added to the precursor of the solid catalyst component, and further the halogenated metal compound (II) and the internal electron donor (III) are added in an arbitrary order to produce a solid component;
(2-5) a process in which the internal electron donor (III) is added to the precursor of the solid catalyst component, and further a mixture of the halogenated metal compound (II) and the internal electron donor (III) is added to produce a solid component;
(2-6) a process in which the precursor of the solid catalyst component and the internal electron donor (III) are added to the halogenated metal compound (II) in an arbitrary order to produce a solid component; and
(2-7) a process in which a mixture of the precursor of the solid catalyst component and the internal electron donor (III) is added to the halogenated metal compound (II) to produce a solid component.

The solid component obtained by any of processes (2-1) to (2-7) can be used as the solid catalyst component (A). Preferable process is any one of processes (2-1), (2-2), (2-4) and (2-5). A solid component obtained by adding the halogenated metal compound, once or more times, to the solid component which has been obtained by any of processes (2-1) to (2-7), and a solid component obtained by adding the halogenated metal compound and the internal electron donor (III), once or more times in an arbitrary order, to the solid component obtained by any of processes (2-1) to (2-7) or a solid component obtained by adding a mixture of the halogenated metal compound and the internal electron donor (III), once or more times, to the solid component which has been obtained by any of processes (2-1) to (2-7), can also be used as the solid catalyst component (A).

The following processes are particularly preferred.

A process for producing the solid catalyst component (A) in which the halogenated metal compound and the internal electron donor (III) each are separately added to the solid component obtained by any one of processes (2-1) to (2-7) once or more times, preferably twice to five times.

A process for producing the solid catalyst component (A) in which a mixture of the halogenated metal compound and the internal electron donor (III) is added to the solid component obtained by any one of processes (2-1) to (2-7) once or more times, preferable twice to five times.

A process for producing the solid catalyst component (A) in which the halogenated metal compound and the internal electron donor (III) each are separately added to the solid component obtained by any one of processes (2-1) to (2-7) once or more times, preferably twice to five times.

It is more preferable to use a solid component obtained by any one of processes (2-1), (2-2), (2-4) and (2-5).

In step (2), the process of contact is not particularly limited. Examples of the process include such publicly known processes as a slurry process and a mechanical pulverization process (for example, a process of pulverizing the compounds using a ball mill). In order to decrease the content of a fine powder in a resulting solid catalyst component (A) or inhibit the particle size distribution of the solid catalyst component (A) from broadening, the mechanical pulverization process is preferably performed in the presence of the solvent described above.

The slurry concentration in the slurry process is usually from 0.05 g-solid/ml-solvent to 0.7 g-solid/m-solvent, particularly preferably from 0.1 g-solid/ml-solvent to 0.5 g-solid/ml-solvent. The contact temperature is usually from 30° C. to 150° C., preferably from 45° C. to 135° C., particularly preferably from 60° C. to 120° C. The contact time is usually preferably from about 30 minutes to about 6 hours.

It is preferable to wash the solid component obtained in the course of step (2) and the solid catalyst component (A) resulting from step (2) with a solvent in order to remove undesired substances. A solvent inert to the solid component and the solid catalyst component is preferable. Examples of such a solvent include aliphatic hydrocarbons such as pentane, hexane, heptane and octane; aromatic hydrocarbons such as benzene, toluene and xylene; alicyclic hydrocarbons such as cyclohexane and cyclopentane; and halogenated hydrocarbons such as 1,2-dichloroethane and monochlorobenzene. Aromatic hydrocarbons and halogenated hydrocarbons are particularly preferable. The amount of the solvent to be used for washing the solid catalyst component (A) is usually from 0.1 ml to 1000 ml, preferably from 1 ml to 100 ml per gram of the precursor of the solid catalyst component to be used, in one stage of contact. Washing the solid catalyst component (A) is usually performed once to five times in each stage of contact. The washing temperature in each stage is usually from −50 to 150° C., preferably from 0 to 140° C., more preferably from 60 to 135° C. The washing time is not particularly limited, and it is preferably from 1 to 120 minutes, more preferably from 2 to 60 minutes.

The solid catalyst component (A) of the present invention and the organoaluminum compound (B) are brought into contact with each other by a publicly known process to produce the solid catalyst for olefin polymerization. It is also possible to produce the solid catalyst for olefin polymerization, the solid catalyst component (A) of the present invention, the organoaluminum compound (B), and the external electron donor (C) by bringing into contact with each other.

Examples of the organoaluminum compound (B) to be used in the present invention include compounds described in JP-A-10-212319. A trialkyl aluminum, a mixture of a trialkyl aluminum and a dialkyl aluminum halide, and an alkyl alumoxane are preferable; and triethyl aluminum, triisobutyl aluminum, a mixture of triethyl aluminum and diethyl aluminum chloride, and tetraethyl dialumoxane are more preferable.

Examples of the external electron donor (C) optionally to be used in the present invention include compounds described in JP-B-2950168, JP-A-2006-96936, JP-A-2009-173870, and JP-A-2010-168545. Oxygen-containing compounds and nitrogen-containing compounds are preferable. Examples of the oxygen-containing compound include alkoxysilicons, ethers, esters, and ketones. Alkoxysilicons and ethers are preferable.

Compounds represented by any of Formulae (v) to (vii) are preferable as the alkoxysilicon for the external electron donor (C):

R¹⁸ₕSi(OR¹⁹)₄₋ₕ (v)

Si(OR²⁰)₃(NR²¹R²²) (vi)

Si(OR²⁰)₃(NR²³) (vii)

where R¹⁸ is a hydrocarbyl group having 1 to 20 carbon atoms or a hydrogen atom; R¹⁹ is a hydrocarbyl group having 1 to 20 carbon atoms; and h is an integer number satisfying 0≦h<4. When there are multiple R¹⁸s, the R¹⁸s may be the same as or different from each other. When there are multiple R¹⁹s, the R¹⁹s may be the same as or different from each other. R²⁰ is a hydrocarbyl group having 1 to 6 carbon atoms; each of R²¹ and R²² is a hydrogen atom or a hydrocarbyl group having 1 to 12 carbon atoms; and NR²³ is a cyclic amino group having 5 to 20 carbon atoms.

In Formula (v), examples of the hydrocarbyl group as R¹⁸ and R¹⁹ include an alkyl group, an aralkyl group, an aryl group, and an alkenyl group. Examples of the alkyl group as R¹⁸ and R¹⁹ include linear alkyl groups such as a methyl group, an ethyl group, a n-propyl group, a n-butyl group, a n-pentyl group, a n-hexyl group, a n-heptyl group and a n-octyl group; branched alkyl groups such as an isopropyl group, an isobutyl group, a tert-butyl group, an isopentyl group, a neopentyl group and a 2-ethylhexyl group; and cyclic alkyl groups such as a cyclopropyl group, a cyclobutyl group, a cyclopentyl group, a cyclohexyl group, a cycloheptyl group and a cyclooctyl group. Linear, branched or cyclic alkyl groups having 1 to 20 carbon atoms are preferable. Examples of the aralkyl group as R¹⁸ and R¹⁹ include a benzyl group and a phenethyl group, and aralkyl groups having 7 to 20 carbon atoms are preferable. Examples of the aryl group as R¹⁸ and R¹⁹ include a phenyl group, a tolyl group and a xylyl group, and aryl groups having 6 to 20 carbon atoms are preferable. Examples of the alkenyl group as R¹⁸ and R¹⁹ include linear alkenyl groups such as a vinyl group, an allyl group, a 3-butenyl group and a 5-hexenyl group; branched alkenyl groups such as an isobutenyl group and a 5-methyl-3-pentenyl group; and cyclic alkenyl groups such as a 2-cyclohexenyl group and a 3-cyclohexenyl group. Alkenyl groups having 2 to 10 carbon atoms are preferable.

Examples of the alkoxysilicon represented by Formula (v) include cyclohexylmethyldimethoxysilane, cyclohexylethyldimethoxysilane, diisopropyklimethoxysilane, tert-butylethyldimethoxysilane, tert-butyl-n-propyldimethoxysilane, phenyltrimethoxysilane, diphenyldimethoxysilane, dicyclobutyldimethoxysilane, dicyclopentyldimethoxysilane, tetraethoxysilane, methyltriethoxysilane, ethyltriethoxysilane, isobutyltriethoxysilane, vinyltriethoxysilane, sec-butyltriethoxysilane, cyclohexyltriethoxysilane, and cyclopentyltriethoxysilane.

Examples of the hydrocarbyl group as R²⁰ in Formulae (vi) and (vii) include an alkyl group and an alkenyl group. Examples of the alkyl group as R²⁰ include linear alkyl groups such as a methyl group, an ethyl group, a n-propyl group, a n-butyl group, a n-pentyl group and a n-hexyl group; branched alkyl groups such as an isopropyl group, an isobutyl group, a tert-butyl group, an isopentyl group and a neopentyl group; and cyclic alkyl groups such as a cyclopropyl group, a cyclobutyl group, a cyclopentyl group and a cyclohexyl group. Linear alkyl groups having 1 to 6 carbon atoms are preferable. Examples of the alkenyl group as R²⁰ include linear alkenyl groups such as a vinyl group, an allyl group, a 3-butenyl group and a 5-hexenyl group; branched alkenyl groups such as an isobutenyl group and a 5-methyl-3-pentenyl group; and cyclic alkenyl groups such as a 2-cyclohexenyl group and a 3-cyclohexenyl group. Linear alkenyl groups having 2 to 6 carbon atoms are preferable, and a methyl group and an ethyl group are particularly preferable.

Examples of the hydrocarbyl group as R²¹ and R²² in Formula (vi) include an alkyl group and an alkenyl group. Examples of the alkyl group as R²¹ and R²² include linear alkyl groups such as a methyl group, an ethyl group, a n-propyl group, a n-butyl group, a n-pentyl group and a n-hexyl group; branched alkyl groups such as an isopropyl group, an isobutyl group, a tert-butyl group, an isopentyl group and a neopentyl group; and cyclic alkyl groups such as a cyclopropyl group, a cyclobutyl group, a cyclopentyl group and a cyclohexyl group. Linear alkyl groups having 1 to 6 carbon atoms are preferable. Examples of the alkenyl group as R²¹ and R²² include linear alkenyl groups such as a vinyl group, an allyl group, a 3-butenyl group and a 5-hexenyl group; branched alkenyl groups such as an isobutenyl group and a 5-methyl-3-pentenyl group; and cyclic alkenyl groups such as a 2-cyclohexenyl group and a 3-cyclohexenyl group. Linear alkenyl groups having 2 to 6 carbon atoms are preferable, and a methyl group and an ethyl group are particularly preferable.

Specific examples of the alkoxysilicon represented by Formula (vi) include dimethylaminotrimethoxysilane, diethylaminotrimethoxysilane, di-n-propylaminotrimethoxysilane, dimethylaminotriethoxysilane, diethylaminotriethoxysilane, di-n-propylaminotriethoxysilane, methylethylaminotriethoxysilane, methyl-n-propylaminotriethoxysilane, tert-butylaminotriethoxysilane, diisopropylaminotriethoxysilane, and methylisopropylaminotriethoxysilane.

Examples of the cyclic amino group as NR²³ in Formula (vii) include a perhydroquinolino group, a perhydroisoquinolino group, a 1,2,3,4-tetrahydroquinolino group, a 1,2,3,4-tetrahydroisoquinolino group, and an octamethyleneimino group.

Specific examples of the alkoxysilicon represented by Formula (vii) include perhydroquinolinotriethoxysilane, perhydroisoquinolinotriethoxysilane, 1,2,3,4-tetrahydroquinolinotriethoxysilane, 1,2,3,4-tetrahydroisoquinolinotriethoxysilane, and octamethyleneiminotriethoxysilane.

The ether to be used as the external electron donor (C) is preferably a cyclic ether compound. The cyclic ether compound refers to any heterocyclic compound having at least one —C—O—C— bond in its ring structure. Cyclic ether compounds having at least one —C—O—C—O—C— bond in the ring structure are more preferable, and 1,3-dioxolane and 1,3-dioxane are particularly preferable.

The external electron donor (C) may be used alone, or two or more compounds may be used in combination as the external electron donor (C).

The process for bringing the solid catalyst component (A), the organoaluminum compound (B), and, optionally, the external electron donor (C) into contact with each other is not particularly limited so long as the solid catalyst for olefin polymerization can be produced. They are brought into contact with each other in the presence or absence of a solvent. A mixture obtained by the contact may be added to a polymerization zone; the individual components may be added separately to a polymerization zone, thereby bringing them into contact with each other in the polymerization zone; or a mixture obtained by bringing any two components into contact with each other and the other component may be added separately to a polymerization tank, thereby bringing them into contact with each other in the polymerization zone.

Examples of the olefin to be used in the process of the present invention for producing an olefin polymer include ethylene, and α-olefins having 3 or more carbon atoms. Examples of the α-olefin include linear monoolefins such as propylene, 1-butene, 1-pentene, 1-hexene, 1-heptene, 1-octene and 1-decene; branched monoolefins such as 3-methyl-1-butene, 3-methyl-1-pentene and 4-methyl-1-pentene; cyclic monoolefins such as vinylcyclohexane; and combinations thereof. Homopolymers of ethylene or propylene, and copolymers of two or more olefins containing ethylene or propylene as a main component are preferable. The combination of two or more olefins may include combinations of an olefin and a compound having multiple unsaturated bonds such as a conjugated diene or a nonconjugated diene.

Preferable examples of the olefin polymer to be produced in the process of the present invention for producing an olefin polymer include an ethylene homopolymer, a propylene homopolymer, a 1-butene homopolymer, a 1-pentene homopolymer, a 1-hexene homopolymer, an ethylene-propylene copolymer, an ethylene-1-butene copolymer, an ethylene-1-hexene copolymer, a propylene-1-butene copolymer, a propylene-1-hexene copolymer, an ethylene-propylene-1-butene copolymer, an ethylene-propylene-1-hexene copolymer, and polymers obtained by multistage polymerization thereof.

The solid catalyst of the present invention for olefin polymerization may be preferably produced by the process including the following steps:

(i) a step of polymerizing a small amount of an olefin, which is the same as or different from the olefin to be used in the main polymerization stage, which is usually referred to as main polymerization, in the presence of the solid catalyst component (A) and the organoaluminum compound (B) (in order to control the molecular weight of the olefin polymer to be produced, a chain transfer agent such as hydrogen may be used, or an external electron donor (C) may be used), whereby a catalyst component whose surface is covered with the olefin polymer is produced, wherein the polymerization is usually referred to as “prepolymerization,” and accordingly the obtained catalyst component is usually referred to as a “prepolymerized catalyst component”, and
(ii) a step of bringing the prepolymerized catalyst component, the organoaluminum compound (B), and the external electron donor (C) into contact with each other.

The prepolymerization is preferably slurry polymerization using an inert hydrocarbon such as propane, butane, isobutane, pentane, isopentane, hexane, heptane, octane, cyclohexane, benzene or toluene as a solvent.

The organoaluminum compound (B) is used in step (i) in an amount of usually 0.5 mol to 700 mol, preferably 0.8 mol to 500 mol, particularly preferably 1 mol to 200 mol per mole of the titanium atoms in the solid catalyst component (A) to be used in step (i).

The olefin to be prepolymerized is used in an amount of usually 0.01 g to 1000 g, preferably 0.05 g to 500 g, particularly preferably 0.1 g to 200 g per gram of the solid catalyst component (A) to be used in step (i).

In the slurry polymerization of step (i), the slurry of the solid catalyst component (A) has a concentration of preferably 1 to 500 g of the solid catalyst component per liter of the solvent, particularly preferably 3 to 300 g of the solid catalyst component per liter of the solvent.

The prepolymerization temperature is preferably from −20° C. to 100° C., particularly preferably from 0° C. to 80° C. In the prepolymerization, the partial pressure of the olefin in the gas phase is preferably from 0.01 MPa to 2 MPa, particularly preferably from 0.1 MPa to 1 MPa, except for olefins which are liquid at the prepolymerization pressure or temperature. The prepolymerization time is preferably from 2 minutes to 15 hours.

In the prepolymerization, examples of the process of adding the solid catalyst component (A), the organoaluminum compound (B) and the olefin to a polymerization zone include the following processes (1) and (2):

(1) a process in which the solid catalyst component (A) and the organoaluminum compound (B) are added to a polymerization zone, and then the olefin is added thereto; and
(2) a process in which the solid catalyst component (A) and the olefin are added to a polymerization zone, and then the organoaluminum compound (B) is added thereto.

In the prepolymerization, examples of the process of adding an olefin to a polymerization zone include the following processes (1) and (2):

(1) a process in which an olefin is sequentially added to a polymerization zone so that an inner pressure of the polymerization zone can be kept at a prescribed level; and
(2) a process in which a prescribed amount of an olefin is added to a polymerization zone at once.

In the prepolymerization, the external electron donor (C) is used in an amount of usually 0.01 mol to 400 mol, preferably 0.02 mol to 200 mol, particularly preferably 0.03 mol to 100 mol per mole of the titanium atoms contained in the solid catalyst component (A), and usually 0.003 mol to 5 mol, preferably 0.005 mol to 3 mol, particularly preferably 0.01 mol to 2 mol per mole of the organoaluminum compound (B).

In the prepolymerization, examples of the process of adding the external electron donor (C) to a polymerization zone include the following processes (1) and (2):

(1) a process in which an external electron donor (C) is added to a polymerization zone alone; and
(2) a process in which a mixture obtained by bringing an external electron donor (C) and an organoaluminum compound (B) into contact with each other is added to a polymerization zone.

In the main polymerization, the organoaluminum compound (B) is used in an amount of usually 1 mol to 1000 mol, particularly preferably 5 mol to 600 mol per mole of the titanium atoms in the solid catalyst component (A).

In the main polymerization, when the external electron donor (C) is used, the external electron donor (C) is used in an amount of usually 0.1 mol to 2000 mol, preferably 0.3 mol to 1000 mol, particularly preferably 0.5 mol to 800 mol per mole of the titanium atoms contained in the solid catalyst component (A), and usually 0.001 mol to 5 mol, preferably 0.005 mol to 3 mol, particularly preferably 0.01 mol to 1 mol per mole of the organoaluminum compound (B).

In the main polymerization, the polymerization temperature is usually from −30° C. to 300° C., preferably from 20° C. to 180° C. The polymerization pressure is not particularly limited, and it is usually from an ordinary pressure to 10 MPa, preferably from about 200 kPa to about 5 MPa because these pressures are industrially and economically advantageous. The polymerization may be either batch polymerization or continuous polymerization. Examples of the polymerization process include a slurry polymerization process and a solution polymerization process, in which an inactive hydrocarbon such as propane, butane, isobutane, pentane, hexane, heptane and octane is used as a solvent; a bulk polymerization process in which an olefin that is liquid at the polymerization temperature is used as a medium; and a gas phase polymerization process.

In order to control the molecular weight of a polymer resulting from the main polymerization, a chain transfer agent, e.g., such as hydrogen, or a alkyl zinc such as dimethyl zinc or diethyl zinc, may be used.

According to the present invention, a solid catalyst for olefin polymerization being capable of showing a sufficiently high polymerization activity and providing a polymer having a low content of a low molecular weight component or an amorphous component, and a solid catalyst component for olefin polymerization, which is used for producing the solid catalyst, can be obtained. Also, when an olefin is polymerized using the solid catalyst, an olefin polymer having a low content of a low molecular weight component or an amorphous component can be obtained. The solid catalyst component of the present invention is particularly preferable as a catalyst for producing an isotactic stereoregular α-olefin polymer.

As a measure of isotactic stereoregularity, an isotactic pentad fraction may be used. When the α-olefin is propylene, the isotactic pentad fraction here is a fraction of propylene monomer units existing at the center of an isotactic linkage expressed in pentad unit in crystalline polypropylene molecular chains, in other words, a linkage consisting of five propylene monomer units continuously meso-bonded to each other, which can be measured by using ¹³C-NMR in accordance with the process described in A. Zambelli et al., Macromolecules, 1973, 6, pp. 925 to 926. The assignment of NMR absorption peak may be based on the description of Macromolecules, 1975, 8, pp. 687 to 689. The isotactic pentad fraction may be abbreviated as [mmmm]. The theoretical upper limit of mmmm is 1.000. The solid catalyst of the present invention is preferable as a solid catalyst for producing an isotactic stereoregular α-olefin polymer having an mmmm of 0.900 or more, more preferably 0.940 or more, further preferably 0.950 or more.

The present invention will be explained in detail by way of examples and comparative examples, but the present invention is not particularly limited thereto.

### [Analysis of Catalyst]

A composition analysis of a solid catalyst component was performed as follows.

With respect to the content of titanium atoms, about 20 mg of a solid sample was decomposed in about 30 ml of a 2 N diluted sulfuric acid. 3 ml of a 3% by weight aqueous hydrogen peroxide solution was added thereto, characteristic absorption at 410 nm of the obtained liquid sample was measured using a double beam spectrophotometer U-2001 manufactured by Hitachi, Ltd, and the content of titanium atoms was determined on the base of on a calibration curve produced in advance. With respect to the content of alkoxy groups, about 2 g of a solid sample was decomposed in 100 ml of water, then an amount of an alcohol corresponding to alkoxy groups in the obtained liquid sample was determined by internal standard gas chromatography, and the obtained amount of the alcohol was converted to the content of alkoxy groups. With respect to the content of internal donor compounds, about 300 mg of a solid catalyst component was dissolved in 100 ml of N,N-dimethylacetamide, and then the content of internal donor compounds in the solution was determined by internal standard gas chromatography.

### [Analysis of Polymer]

### (1) Amount of Xylene-Soluble Component (CXS: Unit=% by Weight)

The amount of components, soluble in xylene at 20° C. of an olefin polymer (hereinafter referred to as CXS) was measured as follows. In 200 ml of boiling xylene was dissolved 1 g of the polymer, and the temperature of the mixture was gradually decreased to 50° C. Then the mixture was immersed in ice water and stirred to cool to 20° C., and was allowed to stand at 20° C. for 3 hours, and then a precipitated polymer was collected by filtration. The percentage by weight of the polymer remaining in the filtrate was expressed as CXS.

(2) Intrinsic Viscosity ([η]: Unit: dl/g)

The intrinsic viscosity (hereinafter represented by [η]) of an olefin polymer was measured at 135° C. in tetralin.

(3) Isotactic Pentad Fraction ([mmmm])

In a 10 mmφ test tube, about 200 mg of a polymer was dissolved in 3 ml of ortho-dichlorobenzene to prepare a sample, and the sample was measured by ¹³C-NMR. The measurement conditions of ¹³C-NMR are shown below.

### Measurement Temperature: 135° C.;

Pulse Repetition Time: 10 seconds;

### Pulse Width: 45°;

Cumulated Number: 2500 times;

The isotactic pentad fraction was calculated from the measurement result in accordance with the process described above.

### Example 1

### (1) Synthesis of Precursor of Solid Catalyst Component for Olefin Polymerization

After the atmosphere in a separable flask having an internal volume of 500 ml and equipped with a stirrer was replaced by nitrogen, 216 ml of hexane (a solvent), 8.9 ml of tetrabutoxytitanium (a titanium compound), 88.5 ml of tetraethoxysilane (a silicon compound containing a Si—O bond), and 1.5 ml of ethyl benzoate were added to the flask to form a mixture. The temperature in the mixture was decreased to 7° C. while stirring the mixture. While the temperature of the mixture was kept at 7° C., 204 ml of a dibutyl ether solution (concentration: 2.1 mol/l) of butyl magnesium chloride (an organomagnesium compound) was added dropwise to the flask at a constant dropping speed over 4 hours to form a reaction mixture. After the addition of butyl magnesium chloride was finished, the temperature of the reaction mixture was adjusted to 20° C., and the reaction mixture was stirred for 1 hour. After finishing the stirring, a supernatant of the reaction mixture was removed by decantation to give a solid. The obtained solid was washed three times with 215 ml of toluene. After that, to the washed solid was added 215 ml of toluene to obtain a mixture. The mixture temperature was elevated to 70° C., and the mixture was stirred at that temperature for 1 hour to give a slurry of a precursor of a solid catalyst component. A part of the slurry was sampled, and the composition of the part was analyzed. As a result, the precursor of the solid catalyst component contained 2.19% by weight of titanium atoms, 40.0% by weight of ethoxy groups, and 3.87% by weight of butoxy groups. The slurry contained the precursor of the solid catalyst component in an amount (a slurry concentration) of 0.219 g/ml.

### (2) Synthesis of Solid Catalyst Component for Olefin Polymerization

After the atmosphere in a 100 ml-flask equipped with a stirrer, a dropping funnel, and a thermometer was replaced by nitrogen, the slurry obtained in Example 1 (1) was added to the flask so that the amount of the precursor of the solid catalyst component might be 8.00 g. From the slurry was removed 10 ml of toluene to adjust the concentration of the slurry to 0.40 g of the precursor of the solid catalyst per ml of the solvent. The temperature of the contents in the flask was adjusted to 10° C., and 16 ml of titanium tetrachloride and 2.56 ml of ethyl 3-ethoxy-2-tert-butylpropionate were added to the flask. After that, the temperature of the contents in the flask was elevated to 115° C., and the contents in the flask were stirred at that temperature for 4 hours. Subsequently, solid-liquid separation of the stirred mixture was performed to give a solid. The solid was washed three times with 40 ml of toluene at 115° C., and 15 ml of toluene was added to the washed solid to form a slurry. To the slurry was added 16 ml of titanium tetrachloride to form a mixture, and the mixture was stirred at 105° C. for 1 hour. After that, solid-liquid separation of the stirred mixture was performed to give a solid. The solid was washed twice with 40 ml of toluene at 105° C., and 15 ml of toluene was added to the washed solid to form a slurry. To the slurry was added 16 ml of titanium tetrachloride to form a mixture, and the mixture was stirred at 105° C. for 1 hour. After that, solid-liquid separation of the stirred mixture was performed to give a solid. The solid was washed twice with 40 ml of toluene at 105° C., and 15 ml of toluene was added to the washed solid to form a slurry. To the slurry was added 16 ml of titanium tetrachloride to form a mixture, and the mixture was stirred at 105° C. for 1 hour. After that, solid-liquid separation of the stirred mixture was performed to give a solid. The solid was washed three times with 40 ml of toluene at 105° C., and additionally with 40 ml of hexane three times at room temperature. The washed solid was dried under reduced pressure, so that 8.07 g of a solid catalyst component for olefin polymerization was obtained. The results of the analysis of the solid catalyst component are shown in Table 1.

### (3) Polymerization of Propylene

A 3-liter stainless steel autoclave equipped with an agitator was dried under reduced pressure, and then was purged with argon gas. The autoclave was cooled, and then evacuated. To the autoclave were added 2.63 mmol of triethyl aluminum (an organoaluminum compound), 0.26 mmol of cyclohexylethyldimethoxysilane (an external electron donor), and 8.76 mg of the solid catalyst component for olefin polymerization synthesized in Example 1 (2). Subsequently, 780 g of propylene and 0.2 MPa of hydrogen were added to the autoclave. The temperature of the autoclave was elevated to 80° C., and propylene was polymerized at 80° C. for 1 hour. After the polymerization reaction was finished, unreacted monomers were purged to obtain a polymer. The polymer was dried at 60° C. for one hour under reduced pressure, so that 397 g of a propylene polymer powder was obtained. The polymerization activity, which is expressed by the amount of the polymer produced per gram of the catalyst, was 45,300 g-PP/g-solid catalyst component. The polymer had a CXS of 2.6% by weight, and a [η] of 0.96 dl/g. The obtained results are shown in Table 1.

### Example 2

### (1) Synthesis of Solid Catalyst Component for Olefin Polymerization

The same procedure as in Example 1 (2) was performed except that the amount of ethyl 3-ethoxy-2-tert-butylpropionate used was changed to 3.2 ml, so that 7.35 g of a solid catalyst component for olefin polymerization was obtained. The results of the analysis of the solid catalyst component for olefin polymerization are shown in Table 1.

### (2) Polymerization of Propylene

The same procedure as in Example 1 (3) was performed except that 8.67 mg of the solid catalyst component for olefin polymerization synthesized in Example 2 (1) was used as the solid catalyst component, so that 373 g of a propylene polymer was obtained. The polymerization activity was 43,000 g-PP/g-solid catalyst component. The polymer had a CXS of 2.2% by weight, and an [η] of 1.0 dl/g. The obtained results are shown in Table 1.

### Comparative Example 1

### (1) Synthesis of Solid Catalyst Component for Olefin Polymerization

The same procedure as in Example 1 (2) was performed except that 2.56 ml of diisobutyl phthalate was used in place of 2.56 ml of ethyl 3-ethoxy-2-tert-butylpropionate in Example 1 (2), so that 8.84 g of a solid catalyst component for olefin polymerization was obtained. The results of the analysis of the solid catalyst component for olefin polymerization are shown in Table 1.

### (2) Polymerization of Propylene

The same procedure as in Example 1 (3) was performed except that 4.95 mg of the solid catalyst component synthesized in Comparative Example 1 (1) was used as the solid catalyst component, so that 196 g of a propylene polymer was obtained. The polymerization activity was 39,600 g-PP/g-solid catalyst component. The polymer had a CXS of 3.4% by weight, and an [η] of 1.0 dl/g. The obtained results are shown in Table 1.

TABLE 1

| | Synthesis conditions for | | | | | | | | | |
|---|---|---|---|---|---|---|---|---|---|---|
| | solid catalyst component | | Results of analysis of solid catalyst component | | | | | Polymerization results | | |
| | Internal electron | | | | | Internal electron | | Polymerization | | |
| | donor (III) | | Content of | Alkoxy group | | donor | | activity | | |
| | | Addition | titanium atoms | | Content | | Content | g-PP/g-solid | CXS | [η] |
| | Kind | amount | % by weight | Kind | % by weight | Kind | % by weight | catalyst component | % by weight | dl/g |
| Example 1 | A | 0.32 | 4.81 | EtO- | 0.17 | A | 13.1 | 45,300 | 2.6 | 0.96 |
| Example 2 | A | 0.40 | 4.45 | EtO- | 0.17 | A | 13.2 | 43,000 | 2.2 | 1.04 |
| Comparative | B | 0.32 | 5.03 | EtO- | 0.20 | B | 8.24 | 39,600 | 3.4 | 1.04 |
| Example 1 | | | | | | | | | | |

Addition amount unit: ml/g of precursor of solid catalyst component
A = ethyl 3-ethoxy-2-tert-butylpropionate
B = diisobutyl phthalate

### Example 3

### (1) Synthesis of Solid Catalyst Component for Olefin Polymerization

Step (2-1 A): After the atmosphere in a 100 ml-flask equipped with a stirrer, a dropping funnel, and a thermometer was replaced by nitrogen, a slurry containing the precursor of the solid catalyst component for olefin polymerization described in Example 1 (1) of JP-A-2004-182981 and toluene was added to the flask so that the amount of the precursor might be 8.00 g. From the slurry was removed toluene to adjust the concentration of the slurry to 0.40 g of the precursor of the solid catalyst per ml of the solvent. The temperature of the slurry in the flask was adjusted to 80° C., and the slurry was stirred for 30 minutes. Then, the temperature of the stirred slurry in the flask was adjusted to 10° C., and a mixture of 16 ml of titanium tetrachloride and 0.8 ml of dibutyl ether, and 2.4 ml of ethyl 3-ethoxy-2-tert-butylpropionate were added to the flask. After that, the temperature of the contents in the flask was elevated to 100° C., and the contents in the flask were stirred at that temperature for 3 hours. Subsequently, solid-liquid separation of the stirred mixture was performed to give a solid. The solid was washed with 40 ml of toluene three times at 100° C.

Step (2-1 B): To the washed solid, 15 ml of toluene was added to form a slurry. To the slurry were added 16 ml of titanium tetrachloride and 0.8 ml of ethyl 3-ethoxy-2-tert-butylpropionate to form a mixture, and the mixture was stirred at 115° C. for 1 hour. After that, solid-liquid separation of the stirred mixture was performed to give a solid. The solid was washed with 40 ml of toluene twice at 115° C.

Step (2-1 C): To the washed solid was added 15 ml of toluene to form a slurry.

To the slurry were added 16 ml of titanium tetrachloride and 0.8 ml of ethyl 3-ethoxy-2-tert-butylpropionate to form a mixture, and the mixture was stirred at 100° C. for 1 hour. After that, solid-liquid separation of the stirred mixture was performed to give a solid. The solid was washed with 40 ml of toluene three times at 100° C., and additionally with 40 ml of hexane three times at room temperature. The washed solid was dried under reduced pressure, so that 8.04 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 11.0 mg of the solid catalyst component for olefin polymerization synthesized in Example 3 (1) was used as the solid catalyst component, so that 338 g of a propylene polymer was obtained. The polymerization activity was 30,700 g-PP/g-solid catalyst component. The polymer had a CXS of 1.5% by weight, an [η] of 0.98 dl/g, and an [mmmm] of 0.960. The obtained results are shown in Table 2.

### Example 4

### (1) Synthesis of Solid Catalyst Component for Olefin Polymerization

Step (2-1 A): The same procedure as in Step (2-1 A) of Example 3 (1) was performed, except that the temperature at which the slurry of the precursor of the solid catalyst component for olefin polymerization was stirred for 30 minutes was changed to 70° C.; 19.2 ml of titanium tetrachloride was used instead of the mixture of 16 ml of titanium tetrachloride and 0.8 ml of dibutyl ether; the temperature in the flask after titanium tetrachloride and ethyl 3-ethoxy-2-tert-butylpropionate were added was changed to 105° C.; the stirring time after adding titanium tetrachloride and ethyl 3-ethoxy-2-tert-butylpropionate was changed to 5 hours; and the temperature at which washing a solid with toluene was performed was changed to 105° C.

Step (2-1 B): The same procedure as in Step (2-1 B) of Example 3 (1) was performed, except that a mixture of 6.4 ml of titanium tetrachloride and 0.8 ml of dibutyl ether was used instead of 16 ml of titanium tetrachloride; the temperature in the flask was changed to 100° C.; the stirring time was changed to 2 hours; and the temperature at which washing with toluene was performed was changed to 100° C.

Step (2-1 C): The same procedure as in Step (2-1 C) of Example 3 (1) was performed, except that a mixture of 6.4 ml of titanium tetrachloride and 0.8 ml of dibutyl ether was used instead of 16 ml of titanium tetrachloride; ethyl 3-ethoxy-2-tert-butylpropionate was not added; the temperature in the flask was changed to 105° C.; and the temperature at which washing with toluene was performed was changed to 105° C., so that 7.83 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 11.7 mg of the solid catalyst component for olefin polymerization synthesized in Example 4 (1) was used as the solid catalyst component, so that 312 g of a propylene polymer was obtained. The polymerization activity was 26,700 g-PP/g-solid catalyst component. The polymer had a CXS of 1.3% by weight, an [η] of 0.99 dl/g, and an [mmmm] of 0.956. The obtained results are shown in Table 2.

### Example 5

### (1) Synthesis of Solid Catalyst Component for Olefin Polymerization

Step (2-1 A): The same procedure as in Step (2-1 A) of Example 3 (1) was performed, except that 16 ml of titanium tetrachloride was used instead of the mixture of 16 ml of titanium tetrachloride and 0.8 ml of dibutyl ether; the amount of ethyl 3-ethoxy-2-tert-butylpropionate used was changed to 2 ml; the temperature in the flask after the addition of titanium tetrachloride and ethyl 3-ethoxy-2-tert-butylpropionate was changed to 115° C.; and the temperature at which washing a solid with toluene was performed was changed to 115° C.

Step (2-1 B): The same procedure as in Step (2-1 B) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml.

Step (2-1 C): The same procedure as in Step (2-1 C) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml, so that 8.24 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 9.95 mg of the solid catalyst component for olefin polymerization synthesized in Example 5 (1) was used as the solid catalyst component, so that 297 g of a propylene polymer was obtained. The polymerization activity was 28,200 g-PP/g-solid catalyst component. The polymer had a CXS of 1.5% by weight, an [η] of 0.96 dl/g, and an [mmmm] of 0.959. The obtained results are shown in Table 2.

### Example 6

### (1) Synthesis of Solid Catalyst Component for Olefin Polymerization

Step (2-1 A): The same procedure as in Step (2-1 A) of Example 3 (1) was performed, except that 16 ml of titanium tetrachloride was used instead of the mixture of 16 ml of titanium tetrachloride and 0.8 ml of dibutyl ether; the amount of ethyl 3-ethoxy-2-tert-butylpropionate used was changed to 1.6 ml; the temperature in the flask after the addition of titanium tetrachloride and ethyl 3-ethoxy-2-tert-butylpropionate was changed to 110° C.; and the temperature at which washing a solid with toluene was performed was changed to 110° C.

Step (2-1 B): The same procedure as in Step (2-1 B) of Example 3 (1) was performed, except that a mixture of 6.4 ml of titanium tetrachloride and 0.8 ml of dibutyl ether was used instead of 16 ml of titanium tetrachloride; the amount of ethyl 3-ethoxy-2-tert-butylpropionate used was changed to 0.4 ml; the temperature in the flask was changed to 105° C.; and the temperature at which washing a solid with toluene was performed was changed to 105° C.

Step (2-1 C): The same procedure as in Step (2-1 C) of Example 3 (1) was performed, except that a mixture of 6.4 ml of titanium tetrachloride and 0.8 ml of dibutyl ether was used instead of 16 ml of titanium tetrachloride; ethyl 3-ethoxy-2-tert-butylpropionate was not added; the temperature in the flask was changed to 105° C.; and the temperature at which washing with toluene was performed was changed to 105° C., so that 7.73 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 11.0 mg of the solid catalyst component for olefin polymerization synthesized in Example 6 (1) was used as the solid catalyst component, so that 261 g of a propylene polymer was obtained. The polymerization activity was 23,600 g-PP/g-solid catalyst component. The polymer had a CXS of 1.8% by weight, an [η] of 0.96 dl/g, and an [mmmm] of 0.949. The obtained results are shown in Table 2.

### Example 7

### (1) Synthesis of Solid Catalyst Component for Olefin Polymerization

Step (2-1 A): The same procedure as in Step (2-1 A) of Example 3 (1) was performed, except that 16 ml of titanium tetrachloride was used instead of the mixture of 16 ml of titanium tetrachloride and 0.8 ml of dibutyl ether; the amount of ethyl 3-ethoxy-2-tert-butylpropionate used was changed to 0.8 ml; the temperature in the flask after the addition of titanium tetrachloride and ethyl 3-ethoxy-2-tert-butylpropionate was changed to 115° C.; and the temperature at which washing a solid with toluene was performed was changed to 115° C.

Step (2-1 B): The same procedure as in Step (2-1 B) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml.

Step (2-1 C): The same procedure as in Step (2-1 C) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml, so that 8.33 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 4.92 mg of the solid catalyst component for olefin polymerization synthesized in Example 7 (1) was used as the solid catalyst component, so that 140 g of a propylene polymer was obtained. The polymerization activity was 28,500 g-PP/g-solid catalyst component. The polymer had a CXS of 2.4% by weight, an [η] of 1.00 dl/g, and an [mmmm] of 0.948. The obtained results are shown in Table 2.

### Example 8

### (1) Synthesis of Solid Catalyst Component for Olefin Polymerization

Step (2-1 A): The same procedure as in Step (2-1 A) of Example 3 (1) was performed, except that the temperature at which the slurry of the precursor of the solid catalyst component for olefin polymerization was stirred for 30 minutes was changed to 70° C.; and a mixture of 12 ml of titanium tetrachloride, 0.8 ml of dibutyl ether and 4 ml of phenyl trichlorosilane was used instead of the mixture of 16 ml of titanium tetrachloride and 0.8 ml of dibutyl ether.

Step (2-1 B): The same procedure as in Step (2-1 B) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml.

Step (2-1 C): The same procedure as in Step (2-1 C) of Example 3 (1) was performed, except that a mixture of 16 ml of titanium tetrachloride and 0.8 ml of dibutyl ether was used instead of 16 ml of titanium tetrachloride; the amount of ethyl 3-ethoxy-2-tert-butylpropionate used was changed to 0.4 ml; the temperature in the flask was changed to 115° C.; and the temperature at which washing a solid with toluene was performed was changed to 115° C., so that 7.21 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 8.70 mg of the solid catalyst component for olefin polymerization synthesized in Example 8 (1) was used as the solid catalyst component, so that 244 g of a propylene polymer was obtained. The polymerization activity was 28,000 g-PP/g-solid catalyst component. The polymer had a CXS of 1.2% by weight, an [η] of 0.95 dl/g, and an [mmmm] of 0.962. The obtained results are shown in Table 2.

### Example 9

### (1) Synthesis of Solid Catalyst Component for Olefin Polymerization

Step (2-1 A): The same procedure as in Step (2-1 A) of Example 3 (1) was performed, except that the temperature at which the slurry of the precursor of the solid catalyst component for olefin polymerization was stirred for 30 minutes was changed to 70° C.; and a mixture of 8 ml of titanium tetrachloride, 0.8 ml of dibutyl ether and 8 ml of phenyl trichlorosilane was used instead of the mixture of 16 ml of titanium tetrachloride and 0.8 ml of dibutyl ether.

Step (2-1 B): The same procedure as in Step (2-1 B) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml.

Step (2-1 C): The same procedure as in Step (2-1 C) of Example 3 (1) was performed, except that a mixture of 16 ml of titanium tetrachloride and 0.8 ml of dibutyl ether was used instead of 16 ml of titanium tetrachloride; the amount of ethyl 3-ethoxy-2-tert-butylpropionate used was changed to 0.4 ml; the temperature in the flask was changed to 115° C.; and the temperature at which washing a solid with toluene was performed was changed to 115° C., so that 7.35 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 7.71 mg of the solid catalyst component for olefin polymerization synthesized in Example 9 (1) was used as the solid catalyst component, so that 159 g of a propylene polymer was obtained. The polymerization activity was 20,600 g-PP/g-solid catalyst component. The polymer had a CXS of 1.3% by weight, an [η] of 1.01 dl/g, and an [mmmm] of 0.960. The obtained results are shown in Table 2.

### Example 10

### (1) Synthesis of Solid Catalyst Component for Olefin Polymerization

Step (2-1 A): The same procedure as in Step (2-1 A) of Example 3 (1) was performed, except that the temperature at which the slurry of the precursor of the solid catalyst component for olefin polymerization was stirred for 30 minutes was changed to 70° C.

Step (2-1 B): The same procedure as in Step (2-1 B) of Example 3 (1) was performed, except that a mixture of 8 ml of titanium tetrachloride, 0.8 ml of dibutyl ether and 8 ml of phenyl trichlorosilane was used instead of 16 ml of titanium tetrachloride; and the amount of ethyl 3-ethoxy-2-tert-butylpropionate used was changed to 0.4 ml.

Step (2-1 C): The same procedure as in Step (2-1 C) of Example 3 (1) was performed, except that a mixture of 16 ml of titanium tetrachloride and 0.8 ml of dibutyl ether was used instead of 16 ml of titanium tetrachloride; the amount of ethyl 3-ethoxy-2-tert-butylpropionate used was changed to 0.4 ml; the temperature in the flask was changed to 115° C.; and the temperature at which washing a solid with toluene was performed was changed to 115° C., so that 7.64 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 10.0 mg of the solid catalyst component for olefin polymerization synthesized in Example 10 (1) was used as the solid catalyst component, so that 260 g of a propylene polymer was obtained. The polymerization activity was 25,900 g-PP/g-solid catalyst component. The polymer had a CXS of 1.3% by weight, an [η] of 0.93 dl/g, and an [mmmm] of 0.961. The obtained results are shown in Table 2.

### Example 11

### (1) Synthesis of Solid Catalyst Component for Olefin Polymerization

Step (2-1 A): The same procedure as in Step (2-1 A) of Example 3 (1) was performed, except that the temperature at which the slurry of the precursor of the solid catalyst component for olefin polymerization was stirred for 30 minutes was changed to 70° C.

Step (2-1 B): The same procedure as in Step (2-1 B) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml.

Step (2-1 C): The same procedure as in Step (2-1 C) of Example 3 (1) was performed, except that a mixture of 8 ml of titanium tetrachloride, 0.8 ml of dibutyl ether and 8 ml of phenyl trichlorosilane was used instead of 16 ml of titanium tetrachloride; the amount of ethyl 3-ethoxy-2-tert-butylpropionate used was changed to 0.4 ml; the temperature in the flask was changed to 115° C.; and the temperature at which washing a solid with toluene was performed was changed to 115° C., so that 7.26 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 11.4 mg of the solid catalyst component for olefin polymerization synthesized in Example 11 (1) was used as the solid catalyst component, so that 280 g of a propylene polymer was obtained. The polymerization activity was 24,600 g-PP/g-solid catalyst component. The polymer had a CXS of 1.2% by weight, an [η] of 0.98 dl/g, and an [mmmm] of 0.961. The obtained results are shown in Table 2.

### Example 12

### (1) Synthesis of Solid Catalyst Component for Olefin Polymerization

Step (2-1 A): The same procedure as in Step (2-1 A) of Example 3 (1) was performed, except that the temperature at which the slurry of the precursor of the solid catalyst component for olefin polymerization was stirred for 30 minutes was changed to 70° C., and the amount of titanium tetrachloride used was changed to 0.75 ml.

Step (2-1 B): The same procedure as in Step (2-1 B) of Example 3 (1) was performed, except that a mixture of 16 ml of titanium tetrachloride and 0.8 ml of dibutyl ether was used instead of 16 ml of titanium tetrachloride.

Step (2-1 C): The same procedure as in Step (2-1 C) of Example 3 (1) was performed, except that a mixture of 16 ml of titanium tetrachloride and 0.8 ml of dibutyl ether was used instead of 16 ml of titanium tetrachloride; the temperature in the flask was changed to 115° C.; and the temperature at which washing a solid with toluene was performed was changed to 115° C., so that 6.70 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 7.54 mg of the solid catalyst component for olefin polymerization synthesized in Example 12 (1) was used as the solid catalyst component, so that 110 g of a propylene polymer was obtained. The polymerization activity was 14,600 g-PP/g-solid catalyst component. The polymer had a CXS of 1.9% by weight, an [η] of 0.84 dl/g, and an [mmmm] of 0.964. The obtained results are shown in Table 2.

### Example 13

### (1) Synthesis of Solid Catalyst Component for Olefin Polymerization

Step (2-1 A): The same procedure as in Step (2-1 A) of Example 3 (1) was performed, except that the solid product described in Example 1 (1) of JP-A-2003-105020 was used as the precursor of the solid catalyst component for olefin polymerization; 16 ml of titanium tetrachloride was used instead of the mixture of 16 ml of titanium tetrachloride and 0.8 ml of dibutyl ether; the temperature in the flask after the addition of titanium tetrachloride and ethyl 3-ethoxy-2-tert-butylpropionate was changed to 115° C.; and the temperature at which washing a solid with toluene was performed was changed to 115° C.

Step (2-1 B): The same procedure as in Step (2-1 B) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml.

Step (2-1 C): The same procedure as in Step (2-1 C) of Example 3 (1) was performed, except that a mixture of 16 ml of titanium tetrachloride and 0.8 ml of dibutyl ether was used instead of 16 ml of titanium tetrachloride; and the amount of ethyl 3-ethoxy-2-tert-butylpropionate used was changed to 0.4 ml, so that 7.51 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 8.44 mg of the solid catalyst component for olefin polymerization synthesized in Example 13 (1) was used as the solid catalyst component, so that 254 g of a propylene polymer was obtained. The polymerization activity was 30,100 g-PP/g-solid catalyst component. The polymer had a CXS of 1.5% by weight, an [η] of 1.03 dl/g, and an [mmmm] of 0.959. The obtained results are shown in Table 2.

### Example 14

### (1) Synthesis of Solid Catalyst Component for Olefin Polymerization

Step (2-1 A): The same procedure as in Step (2-1 A) of Example 3 (1) was performed, except that 2.4 ml of ethyl 3-ethoxy-2-phenylpropionate was used instead of 2.4 ml of ethyl 3-ethoxy-2-tert-butylpropionate.

Step (2-1 B): The same procedure as in Step (2-1 B) of Example 3 (1) was performed, except that 0.8 ml of ethyl 3-ethoxy-2-phenylpropionate was used instead of 0.8 ml of ethyl 3-ethoxy-2-tert-butylpropionate.

Step (2-1 C): The same procedure as in Step (2-1 C) of Example 3 (1) was performed, except that 0.8 ml of ethyl 3-ethoxy-2-phenylpropionate was used instead of 0.8 ml of ethyl 3-ethoxy-2-tert-butylpropionate, so that 7.86 g of a solid catalyst component for olefin polymerization was obtained. The results of the analysis of the solid catalyst component for olefin polymerization are shown in Table 2.

### (2) Polymerization of Propylene

The same procedure as in Example 1 (3) was performed except that 9.99 mg of the solid catalyst component for olefin polymerization synthesized in Example 14 (1) was used as the solid catalyst component, so that 178 g of a propylene polymer was obtained. The polymerization activity was 17,800 g-PP/g-solid catalyst component. The polymer had a CXS of 2.0% by weight, an [η] of 1.05 dl/g, and an [mmmm] of 0.952. The obtained results are shown in Table 2.

TABLE 2

| | | | | | | | | Results of analysis of | | |
|---|---|---|---|---|---|---|---|---|---|---|
| | | | | | | | | solid catalyst component | | |
| | | Synthesis conditions for solid catalyst component | | | | | | | Content of alkoxy | |
| | | Internal electron | | | | | | | groups | |
| | | donor (III) | | Halogenated metal compound | | | | Content of | EtO- | nBuO- |
| | | | Addition | | Addition | | Addition | titanium atoms | % by | % by |
| | | Kind | amount | Kind | amount | Kind | amount | % by weight | weight | weight |
| Example | Step (2-1 A) | A | 0.30 | Titanium tetrachloride | 18.2 | — | — | 3.14 | 0.26 | 0 |
| 3 | Step (2-1 B) | A | 0.10 | Titanium tetrachloride | 18.2 | — | — | | | |
| | Step (2-1 C) | A | 0.10 | Titanium tetrachloride | 18.2 | — | — | | | |
| Example | Step (2-1 A) | A | 0.30 | Titanium tetrachloride | 21.9 | — | — | 3.52 | 0.21 | 0.08 |
| 4 | Step (2-1 B) | A | 0.10 | Titanium tetrachloride | 7.3 | — | — | | | |
| | Step (2-1 C) | — | — | Titanium tetrachloride | 7.3 | — | — | | | |
| Example | Step (2-1 A) | A | 0.25 | Titanium tetrachloride | 18.2 | — | — | 3.43 | 0.23 | 0.10 |
| 5 | Step (2-1 B) | A | 0.05 | Titanium tetrachloride | 18.2 | — | — | | | |
| | Step (2-1 C) | A | 0.05 | Titanium tetrachloride | 18.2 | — | — | | | |
| Example | Step (2-1 A) | A | 0.20 | Titanium tetrachloride | 18.2 | — | — | 3.90 | 0.25 | 0.08 |
| 6 | Step (2-1 B) | A | 0.05 | Titanium tetrachloride | 7.3 | — | — | | | |
| | Step (2-1 C) | — | — | Titanium tetrachloride | 7.3 | — | — | | | |
| Example | Step (2-1 A) | A | 0.10 | Titanium tetrachloride | 18.2 | — | — | 3.85 | 0.36 | 0.12 |
| 7 | Step (2-1 B) | A | 0.05 | Titanium tetrachloride | 18.2 | — | — | | | |
| | Step (2-1 C) | A | 0.05 | Titanium tetrachloride | 18.2 | — | — | | | |
| Example | Step (2-1 A) | A | 0.30 | Titanium tetrachloride | 13.7 | Phenyltri- | 3.1 | 3.02 | 0.15 | 0.07 |
| 8 | | | | | | chlorosilane | | | | |
| | Step (2-1 B) | A | 0.05 | Titanium tetrachloride | 18.2 | — | — | | | |
| | Step (2-1 C) | A | 0.05 | Titanium tetrachloride | 18.2 | — | — | | | |
| Example | Step (2-1 A) | A | 0.30 | Titanium tetrachloride | 9.1 | Phenyltri- | 6.2 | 2.78 | 0.13 | 0.06 |
| 9 | | | | | | chlorosilane | | | | |
| | Step (2-1 B) | A | 0.05 | Titanium tetrachloride | 18.2 | — | — | | | |
| | Step (2-1 C) | A | 0.05 | Titanium tetrachloride | 18.2 | — | — | | | |
| Example | Step (2-1 A) | A | 0.30 | Titanium tetrachloride | 18.2 | — | — | 3.12 | 0.17 | 0.08 |
| 10 | Step (2-1 B) | A | 0.05 | Titanium tetrachloride | 9.1 | Phenyltri- | 6.2 | | | |
| | | | | | | chlorosilane | | | | |
| | Step (2-1 C) | A | 0.05 | Titanium tetrachloride | 18.2 | — | | | | |
| Example | Step (2-1 A) | A | 0.30 | Titanium tetrachloride | 18.2 | — | — | 2.92 | 0.16 | 0.08 |
| 11 | Step (2-1 B) | A | 0.05 | Titanium tetrachloride | 18.2 | — | — | | | |
| | Step (2-1 C) | A | 0.05 | Titanium tetrachloride | 9.1 | Phenyltri- | 6.2 | | | |
| | | | | | | chlorosilane | | | | |
| Example | Step (2-1 A) | A | 0.30 | Titanium tetrachloride | 6.8 | — | — | 2.27 | 0.13 | 0 |
| 12 | Step (2-1 B) | A | 0.10 | Titanium tetrachloride | 18.2 | — | — | | | |
| | Step (2-1 C) | A | 0.10 | Titanium tetrachloride | 18.2 | — | — | | | |
| Example | Step (2-1 A) | A | 0.30 | Titanium tetrachloride | 18.2 | — | — | 3.43 | 0.20 | 0.07 |
| 13 | Step (2-1 B) | A | 0.05 | Titanium tetrachloride | 18.2 | — | — | | | |
| | Step (2-1 C) | A | 0.05 | Titanium tetrachloride | 18.2 | — | — | | | |
| Example | Step (2-1 A) | C | 0.30 | Titanium tetrachloride | 18.2 | — | — | 2.76 | 0.45 | 0.01 |
| 14 | Step (2-1 B) | C | 0.10 | Titanium tetrachloride | 18.2 | — | — | | | |
| | Step (2-1 C) | C | 0.10 | Titanium tetrachloride | 18.2 | — | — | | | |

| | | Results of analysis of | | | | | |
|---|---|---|---|---|---|---|---|
| | | solid catalyst component | | Polymerization results | | | |
| | | Internal electron | | Polymerization | | | |
| | | donor (III) | | activity | | | |
| | | | Content | g-PP/g-solid | CXS | [η] | |
| | | Kind | % by weight | catalyst component | % by weight | dl/g | [mmmm] |
| Example | Step (2-1 A) | A | 15.1 | 30,700 | 1.5 | 0.98 | 0.960 |
| 3 | Step (2-1 B) | | | | | | |
| | Step (2-1 C) | | | | | | |
| Example | Step (2-1 A) | A | 17.8 | 26,700 | 1.3 | 0.99 | 0.956 |
| 4 | Step (2-1 B) | | | | | | |
| | Step (2-1 C) | | | | | | |
| Example | Step (2-1 A) | A | 14.4 | 28,200 | 1.5 | 0.96 | 0.959 |
| 5 | Step (2-1 B) | | | | | | |
| | Step (2-1 C) | | | | | | |
| Example | Step (2-1 A) | A | 17.6 | 23,600 | 1.8 | 0.96 | 0.949 |
| 6 | Step (2-1 B) | | | | | | |
| | Step (2-1 C) | | | | | | |
| Example | Step (2-1 A) | A | 12.9 | 28,500 | 2.4 | 1.00 | 0.948 |
| 7 | Step (2-1 B) | | | | | | |
| | Step (2-1 C) | | | | | | |
| Example | Step (2-1 A) | A | 16.2 | 28,000 | 1.2 | 0.95 | 0.962 |
| 8 | Step (2-1 B) | | | | | | |
| | Step (2-1 C) | | | | | | |
| Example | Step (2-1 A) | A | 14.2 | 20,600 | 1.3 | 1.01 | 0.960 |
| 9 | Step (2-1 B) | | | | | | |
| | Step (2-1 C) | | | | | | |
| Example | Step (2-1 A) | A | 16.5 | 25,900 | 1.3 | 0.93 | 0.961 |
| 10 | Step (2-1 B) | | | | | | |
| | Step (2-1 C) | | | | | | |
| Example | Step (2-1 A) | A | 16.3 | 24,600 | 1.2 | 0.98 | 0.961 |
| 11 | Step (2-1 B) | | | | | | |
| | Step (2-1 C) | | | | | | |
| Example | Step (2-1 A) | A | 12.1 | 14,600 | 1.9 | 0.84 | 0.964 |
| 12 | Step (2-1 B) | | | | | | |
| | Step (2-1 C) | | | | | | |
| Example | Step (2-1 A) | A | 14.9 | 30,100 | 1.5 | 1.03 | 0.959 |
| 13 | Step (2-1 B) | | | | | | |
| | Step (2-1 C) | | | | | | |
| Example | Step (2-1 A) | C | 20.4 | 17,800 | 2.0 | 1.05 | 0.952 |
| 14 | Step (2-1 B) | | | | | | |
| | Step (2-1 C) | | | | | | |

Internal electron donor (III) addition amount unit: ml/g of precursor or solid catalyst component
Halogenated metal compound addition amount unit: mmol/g of precursor of solid catalyst component
A = ethyl 3-ethoxy-2-tert-butylpropionate
C = ethyl 3-ethoxy-2-phenylpropionate

### Example 15

### (1) Synthesis of Solid Catalyst Component for Olefin Polymerization

Step (2-3 A): After the atmosphere in a 100 ml-flask equipped with a stirrer, a dropping funnel and a thermometer was replaced by nitrogen, a slurry containing a precursor of a solid catalyst component for olefin polymerization described in Example 1 (1) of JP-A-2004-182981 and toluene was added to the flask so that the amount of the precursor might be 8.00 g. From the slurry was removed 0.6 ml of toluene to adjust the slurry concentration to 0.40 g of the precursor of the solid catalyst/ml of the solvent. Subsequently, 6.4 ml of ethyl 3-ethoxy-2-tert-butylpropionate was added to the flask to form a mixture. After that, the temperature of the mixture in the flask was elevated to 100° C., and the mixture in the flask was stirred at the same temperature for 30 minutes. Next, solid-liquid separation of the stirred mixture was performed to obtain a solid. The solid was washed with 40 ml of toluene three times at 100° C. to give a solid.

Step (2-3 B): To the washed solid was added 15 ml of toluene to form a slurry. To the slurry were added a mixture of 16 ml of titanium tetrachloride and 0.8 ml of dibutyl ether, and 2.4 ml of ethyl 3-ethoxy-2-tert-butylpropionate to form a mixture, and the mixture was stirred at 115° C. for 3 hours. After that, solid-liquid separation of the stirred mixture was performed to obtain a solid. The solid was washed with 40 ml of toluene twice at 115° C. to give a solid.

Step (2-3 C): To the washed solid was added 15 ml of toluene to form a slurry. To the slurry were added a mixture of 16 ml of titanium tetrachloride and 0.8 ml of dibutyl ether, and 0.8 ml of ethyl 3-ethoxy-2-tert-butylpropionate to form a mixture, and the mixture was stirred at 115° C. for 1 hour. After that, solid-liquid separation of the stirred mixture was performed to give a solid. The solid was washed twice with 40 ml of toluene at 115° C. to give a solid.

Step (2-3 D): To the washed solid was added 15 ml of toluene to form a slurry. To the slurry were added a mixture of 16 ml of titanium tetrachloride and 0.8 ml of dibutyl ether, and 0.4 ml of ethyl 3-ethoxy-2-tert-butylpropionate to form a mixture, and the mixture was stirred at 115° C. for 1 hour. After that, solid-liquid separation of the stirred mixture was performed to obtain a solid. The solid was washed with 40 ml of toluene three times at 115° C., and additionally with 40 ml of hexane three times at room temperature. The washed solid was dried under reduced pressure, so that 7.03 g of a solid catalyst component for olefin polymerization was obtained. The results of the analysis of the solid catalyst component for olefin polymerization are shown in Table 3.

### (2) Polymerization of Propylene

The same procedure as in Example 1 (3) was performed except that 11.2 mg of the solid catalyst component for olefin polymerization synthesized in Example 15 (1) was used as the solid catalyst component, so that 300 g of a propylene polymer was obtained. The polymerization activity was 26,900 g-PP/g-solid catalyst component. The polymer had a CXS of 1.4% by weight, an [η] of 0.95 dl/g, and an [mmmm] of 0.967. The obtained results are shown in Table 3.

### Example 16

### (1) Synthesis of Solid Catalyst Component for Olefin Polymerization

Step (2-3 A): The same procedure as in Step (2-3 A) of Example 15 (1) was performed, except that the temperature in the flask after the addition of ethyl 3-ethoxy-2-tert-butylpropionate was changed to 80° C.; and the temperature at which washing a solid with toluene was performed was changed to 80° C.

Step (2-3 B): The same procedure as in Step (2-3 B) of Example 15 (1) was performed, except that 16 ml of titanium tetrachloride was used instead of the mixture of 16 ml of titanium tetrachloride and 0.8 ml of dibutyl ether; and the amount of ethyl 3-ethoxy-2-tert-butylpropionate used was changed to 0.8 ml.

Step (2-3 C): The same procedure as in Step (2-3 C) of Example 15 (1) was performed, except that the amount of ethyl 3-ethoxy-2-tert-butylpropionate used was changed to 0.4 ml.

Step (2-3 D): The same procedure as in Step (2-3 D) of Example 15 (1) was performed, except that the mixture in the flask was stirred at 100° C.; and the temperature at which washing a solid with toluene was performed was changed to 100° C., so that 7.09 g of a solid catalyst component for olefin polymerization was obtained. The results of the analysis of the solid catalyst component for olefin polymerization are shown in Table 3.

### (2) Polymerization of Propylene

The same procedure as in Example 1 (3) was performed, except that 5.70 mg of the solid catalyst component for olefin polymerization synthesized in Example 16 (1) was used as the solid catalyst component, so that 134 g of a propylene polymer was obtained. The polymerization activity was 23,500 g-PP/g-solid catalyst component. The polymer had a CXS of 1.9% by weight, an [η] of 0.89 dl/g, and an [mmmm] of 0.959. The obtained results are shown in Table 3.

### Example 17

### (1) Synthesis of Solid Catalyst Component for Olefin Polymerization

Step (2-3 A): The same procedure as in Step (2-3 A) of Example 15 (1) was performed, except that the temperature in the flask after the addition of ethyl 3-ethoxy-2-tert-butylpropionate was changed to 80° C.; and the temperature at which washing a solid with toluene was performed was changed to 80° C.

Step (2-3 B): The same procedure as in Step (2-3 B) of Example 15 (1) was performed, except that the amount of ethyl 3-ethoxy-2-tert-butylpropionate used was changed to 0.8 ml.

Step (2-3 C): The same procedure as in Step (2-3 C) of Example 15 (1) was performed, except that ethyl 3-ethoxy-2-tert-butylpropionate was not added.

Step (2-3 D): The same procedure as in Step (2-3 D) of Example 15 (1) was performed, except that ethyl 3-ethoxy-2-tert-butylpropionate was not added; the mixture in the flask was stirred at 100° C.; and the temperature at which washing a solid with toluene was performed was changed to 100° C., so that 6.87 g of a solid catalyst component for olefin polymerization was obtained. The results of the analysis of the solid catalyst component for olefin polymerization are shown in Table 3.

### (2) Polymerization of Propylene

The same procedure as in Example 1 (3) was performed except that 8.63 mg of the solid catalyst component for olefin polymerization synthesized in Example 17 (1) was used as the solid catalyst component, so that 274 g of a propylene polymer was obtained. The polymerization activity was 31,800 g-PP/g-solid catalyst component. The polymer had a CXS of 2.1% by weight, an [η] of 0.98 dl/g, and an [mmmm] of 0.966. The obtained results are shown in Table 3.

### Example 18

### (1) Synthesis of Solid Catalyst Component for Olefin Polymerization

Step (2-3 A): The same procedure as in Step (2-3 A) of Example 15 (1) was performed, except that the amount of ethyl 3-ethoxy-2-tert-butylpropionate used was changed to 4.8 ml.

Step (2-3 B): The same procedure as in Step (2-3 B) of Example 15 (1) was performed.

Step (2-3 C): The same procedure as in Step (2-3 C) of Example 15 (1) was performed.

Step (2-3 D): The same procedure as in Step (2-3 D) of Example 15 (1) was performed, so that 7.26 g of a solid catalyst component for olefin polymerization was obtained. The results of the analysis of the solid catalyst component for olefin polymerization are shown in Table 3.

### (2) Polymerization of Propylene

The same procedure as in Example 1 (3) was performed except that 8.10 mg of the solid catalyst component for olefin polymerization synthesized in Example 18 (1) was used as the solid catalyst component, so that 216 g of a propylene polymer was obtained. The polymerization activity was 26,700 g-PP/g-solid catalyst component. The polymer had a CXS of 1.6% by weight, an [η] of 0.99 dl/g, and an [mmmm] of 0.966. The obtained results are shown in Table 3.

### Example 19

### (1) Synthesis of Solid Catalyst Component for Olefin Polymerization

Step (2-3 A): The same procedure as in Step (2-3 A) of Example 15 (1) was performed, except that the amount of ethyl 3-ethoxy-2-tert-butylpropionate used was changed to 4.8 ml; the temperature in the flask after addition of ethyl 3-ethoxy-2-tert-butylpropionate was changed to 80° C.; and the temperature at which washing a solid with toluene was preformed was changed to 80° C.

Step (2-3 B): The same procedure as in Step (2-3 B) of Example 15 (1) was performed, except that the amount of titanium tetrachloride used was changed to 6.0 ml; the mixture in the flask was stirred at 100° C.; and the temperature at which washing a solid with toluene was performed was changed to 100° C.

Step (2-3 C): The same procedure as in Step (2-3 C) of Example 15 (1) was performed, except that the amount of ethyl 3-ethoxy-2-tert-butylpropionate used was changed to 0.4 ml.

Step (2-3 D): The same procedure as in Step (2-3 D) of Example 15 (1) was performed, so that 6.99 g of a solid catalyst component for olefin polymerization was obtained. The results of the analysis of the solid catalyst component for olefin polymerization are shown in Table 3.

### (2) Polymerization of Propylene

The same procedure as in Example 1 (3) was performed except that 8.44 mg of the solid catalyst component for olefin polymerization synthesized in Example 19 (1) was used as the solid catalyst component, so that 51.7 g of a propylene polymer was obtained. The polymerization activity was 6,130 g-PP/g-solid catalyst component. The polymer had a CXS of 3.2% by weight, an [η] of 0.83 dl/g, and an [mmmm] of 0.944. The obtained results are shown in Table 3.

### Example 20

### (1) Synthesis of Solid Catalyst Component for Olefin Polymerization

Step (2-3 A): The same procedure as in Step (2-3 A) of Example 15 (1) was performed, except that the amount of ethyl 3-ethoxy-2-tert-butylpropionate used was changed to 4.8 ml; the temperature in the flask after addition of ethyl 3-ethoxy-2-tert-butylpropionate was changed to 80° C.; and the temperature at which washing a solid with toluene was preformed was changed to 80° C.

Step (2-3 B): The same procedure as in Step (2-3 B) of Example 15 (1) was performed.

Step (2-3 C): The same procedure as in Step (2-3 C) of Example 15 (1) was performed, except that 16 ml of titanium tetrachloride was used instead of the mixture of 16 ml of titanium tetrachloride and 0.8 ml of dibutyl ether; the amount of ethyl 3-ethoxy-2-tert-butylpropionate used was changed to 0.4 ml; the mixture in the flask was stirred at 100° C.; and the temperature at which washing a solid with toluene was performed was changed to 100° C.

Step (2-3 D): The same procedure as in Step (2-3 D) of Example 15 (1) was performed, except that the amount of ethyl 3-ethoxy-2-tert-butylpropionate used was changed to 0.8 ml, so that 7.13 g of a solid catalyst component for olefin polymerization was obtained. The results of the analysis of the solid catalyst component for olefin polymerization are shown in Table 3.

### (2) Polymerization of Propylene

The same procedure as in Example 1 (3) was performed except that 10.8 mg of the solid catalyst component for olefin polymerization synthesized in Example 20 (1) was used as the solid catalyst component, so that 293 g of a propylene polymer was obtained. The polymerization activity was 30,000 g-PP/g-solid catalyst component. The polymer had a CXS of 1.5% by weight, an [η] of 1.00 dl/g, and an [mmmm] of 0.966. The obtained results are shown in Table 3.

### Example 21

### (1) Production of Solid Product

A 500 ml flask equipped with a stirrer and a dropping funnel was purged with nitrogen, and thereafter 290 ml of hexane, 3.0 ml (8.8 mmol in terms of Ti atom) of tetrabutoxytitanium, 2.5 ml (9.3 mmol) of di-1-butyl phthalate and 73 ml (326 mmol) of tetraethoxysilane were fed into the flask to obtain a uniform solution.

Successively, 170 ml of a di-n-butyl ether solution of n-butylmagnesium chloride (manufactured by Yuki Gosei Kogyo Co., Ltd., n-butylmagnesium chloride concentration: 2.1 mmol/ml) was gradually added dropwise from the dropping funnel thereto over 4 hours while maintaining a temperature in the flask at 5° C. After completion of the addition, the mixture was stirred at 20° C. for 1 hour. Thereafter, the reaction mixture was cooled to room temperature, and subjected to solid-liquid separation. The solid product separated was washed 3 times with each 215 ml of toluene, and then mixed with 150 ml of toluene. Thereafter, the mixture was stirred for 1 hours at 70° C. and obtained a slurry of the solid product having a slurry concentration of 0.176 g/ml.

After sampling a part of the slurry, a composition analysis was conducted, and as a result, the solid product was found to contain 0.83 wt % of the titanium atom, 0.71 wt % of the phthalic acid ester, 30.5 wt % of the ethoxy group and 1.66 wt % of the butoxy group.

### (2) Synthesis of Solid Catalyst Component for Olefin Polymerization

Step (2-3 A): The same procedure as in Example 15 (1) was performed, except that a slurry containing a precursor of a solid catalyst component for olefin polymerization described in Example 21 (1) was used instead of a slurry containing a precursor of a solid catalyst component for olefin polymerization described in Example 1 (1) of JP-A-2004-182981 and the amount of ethyl 3-ethoxy-2-tert-butylpropionate used was changed to 4.8 ml.

Step (2-3 B): The same procedure as in Example 15 (1) was performed.

Step (2-3 C): The same procedure as in Example 15 (1) was performed.

Step (2-3 D): The same procedure as in Example 15 (1) was performed, so that 6.31 g of a solid catalyst component for olefin polymerization was obtained. The results of the analysis of the solid catalyst component for olefin polymerization are shown in Table 3.

### (3) Polymerization of Propylene

The same procedure as in Example 1 (3) was performed, except that 5.65 mg of the solid catalyst component for olefin polymerization synthesized in Example 21 (1) was used as the solid catalyst component, whereby 256 g of a propylene polymer was obtained. The amount of the polymer produced per unit quantity of the catalyst (a polymerization activity) was 45,300 g of PP/g of the solid catalyst component. The polymer had a CXS of 0.9% by weight, an [η] of 0.99 dl/g, and an [mmmm] of 0.978. The obtained results are shown in Table 3.

### Example 22

### (1) Production of Solid Product

After the atmosphere in a flask having an internal volume of 500 ml and equipped with a stirrer and a dropping funnel was replaced by nitrogen, 290 ml of hexane, 1.5 ml (4.4 mmol in terms of Ti atom) of tetrabutoxytitanium, 2.5 ml (9.3 mmol) of di-1-butyl phthalate and 73 ml (326 mmol) of tetraethoxysilane were fed into the flask to obtain a uniform solution.

Successively, 170 ml of a di-n-butyl ether solution of n-butylmagnesium chloride (manufactured by Yuki Gosei Kogyo Co., Ltd., n-butylmagnesium chloride concentration: 2.1 mmol/ml) was gradually added dropwise from the dropping funnel thereto over 4 hours while maintaining a temperature in the flask at 5° C. After completion of the addition, the mixture was stirred at 20° C. for 1 hour. Thereafter, the reaction mixture was cooled to room temperature, and subjected to solid-liquid separation. The solid product separated was washed with each 215 ml of toluene 3 times, and then mixed with 150 ml of toluene. Thereafter, the mixture was stirred for 1 hour at 70° C. and obtained a slurry of the solid product having a slurry concentration of 0.187 g/ml.

After sampling a part of the slurry, a composition analysis was conducted, and as a result, the solid product was found to contain 0.43 wt % of the titanium atom, 1.3 wt % of the phthalic acid ester, 26.9 wt % of the ethoxy group and 1.25 wt % of the butoxy group.

### (2) Synthesis of Solid Catalyst Component for Olefin Polymerization

Step (2-3 A): The same procedure as in Example 15 (1) was performed, except that a slurry containing a precursor of a solid catalyst component for olefin polymerization described in Example 22 (1) was used instead of a slurry containing a precursor of a solid catalyst component for olefin polymerization described in Example 1 (1) of JP-A-2004-182981 and the amount of ethyl 3-ethoxy-2-tert-butylpropionate used was changed to 4.8 ml.

Step (2-3 B): The same procedure as in Example 15 (1) was performed.

Step (2-3 C): The same procedure as in Example 15 (1) was performed.

Step (2-3 D): The same procedure as in Example 15 (1) was performed, so that 6.48 g of a solid catalyst component for olefin polymerization was obtained. The results of the analysis of the solid catalyst component for olefin polymerization are shown in Table 3.

### (3) Polymerization of Propylene

The same procedure as in Example 1 (3) was performed, except that 5.25 mg of the solid catalyst component for olefin polymerization synthesized in Example 22 (1) was used as the solid catalyst component, so that 187 g of a propylene polymer was obtained. The polymerization activity was 35,600 g-PP/g-solid catalyst component. The polymer had a CXS of 1.1% by weight, an [η] of 0.98 dl/g, and an [mmmm] of 0.976. The obtained results are shown in Table 3.

### Example 23

### (1) Synthesis of Solid Catalyst Component for Olefin Polymerization

Step (2-3 A): The same procedure as in Step (2-3 A) of Example 15 (1) was performed, except that 6.4 ml of ethyl 3-ethoxy-2-phenylpropionate was used instead of 6.4 ml of ethyl 3-ethoxy-2-tert-butylpropionate.

Step (2-3 B): The same procedure as in Step (2-3 B) of Example 15 (1) was performed, except that 2.4 ml of ethyl 3-ethoxy-2-phenylpropionate was used instead of 2.4 ml of ethyl 3-ethoxy-2-tert-butylpropionate.

Step (2-3 C): The same procedure as in Step (2-3 C) of Example 15 (1) was performed, except that 0.8 ml of ethyl 3-ethoxy-2-phenylpropionate was used instead of 0.8 ml of ethyl 3-ethoxy-2-tert-butylpropionate.

Step (2-3 D): The same procedure as in Step (2-3 D) of Example 15 (1) was performed, except that 0.4 ml of ethyl 3-ethoxy-2-phenylpropionate was used instead of 0.4 ml of ethyl 3-ethoxy-2-tert-butylpropionate, so that 6.38 g of a solid catalyst component for olefin polymerization was obtained. The results of the analysis of the solid catalyst component for olefin polymerization are shown in Table 3.

### (2) Polymerization of Propylene

The same procedure as in Example 1 (3) was performed except that 8.48 mg of the solid catalyst component for olefin polymerization synthesized in Example 21 (1) was used as the solid catalyst component, so that 185 g of a propylene polymer was obtained. The polymerization activity was 21,800 g-PP/g-solid catalyst component. The polymer had a CXS of 1.6% by weight, an [η] of 1.00 dl/g, and an [mmmm] of 0.966. The obtained results are shown in Table 3.

TABLE 3

| | | | | | | Results of analysis of | | |
|---|---|---|---|---|---|---|---|---|
| | | | | | | solid catalyst component | | |
| | | Synthesis conditions for solid catalyst component | | | | | Content of alkoxy | |
| | | Internal electron | | | | | groups | |
| | | donor (III) | | Halogenated metal compound | | Content of | EtO- | nBuO- |
| | | | Addition | | Addition | titanium atoms | % by | % by |
| | | Kind | amount | Kind | amount | % by weight | weight | weight |
| Example | Step (2-3 A) | A | 0.80 | — | — | 2.37 | 0.30 | 0.09 |
| 15 | Step (2-3 B) | A | 0.30 | Titanium tetrachloride | 18.2 | | | |
| | Step (2-3 C) | A | 0.10 | Titanium tetrachloride | 18.2 | | | |
| | Step (2-3 D) | A | 0.05 | Titanium tetrachloride | 18.2 | | | |
| Example | Step (2-3 A) | A | 0.80 | — | — | 2.71 | 0.45 | 0.07 |
| 16 | Step (2-3 B) | A | 0.10 | Titanium tetrachloride | 18.2 | | | |
| | Step (2-3 C) | A | 0.05 | Titanium tetrachloride | 18.2 | | | |
| | Step (2-3 D) | A | 0.05 | Titanium tetrachloride | 18.2 | | | |
| Example | Step (2-3 A) | A | 0.80 | — | — | 3.26 | 0.44 | 0.30 |
| 17 | Step (2-3 B) | A | 0.10 | Titanium tetrachloride | 18.2 | | | |
| | Step (2-3 C) | — | — | Titanium tetrachloride | 18.2 | | | |
| | Step (2-3 D) | — | — | Titanium tetrachloride | 18.2 | | | |
| Example | Step (2-3 A) | A | 0.60 | — | — | 2.49 | 0.30 | 0.08 |
| 18 | Step (2-3 B) | A | 0.30 | Titanium tetrachloride | 18.2 | | | |
| | Step (2-3 C) | A | 0.10 | Titanium tetrachloride | 18.2 | | | |
| | Step (2-3 D) | A | 0.05 | Titanium tetrachloride | 18.2 | | | |
| Example | Step (2-3 A) | A | 0.60 | — | — | 1.86 | 0.09 | 0.03 |
| 19 | Step (2-3 B) | A | 0.30 | Titanium tetrachloride | 6.8 | | | |
| | Step (2-3 C) | A | 0.05 | Titanium tetrachloride | 18.2 | | | |
| | Step (2-3 D) | A | 0.05 | Titanium tetrachloride | 18.2 | | | |
| Example | Step (2-3 A) | A | 0.60 | — | — | 2.71 | 0.28 | 0.09 |
| 20 | Step (2-3 B) | A | 0.30 | Titanium tetrachloride | 18.2 | | | |
| | Step (2-3 C) | A | 0.05 | Titanium tetrachloride | 18.2 | | | |
| | Step (2-3 D) | A | 0.10 | Titanium tetrachloride | 18.2 | | | |
| Example | Step (2-3 A) | A | 0.60 | — | — | 1.71 | 0.23 | 0.10 |
| 21 | Step (2-3 B) | A | 0.30 | Titanium tetrachloride | 18.2 | | | |
| | Step (2-3 C) | A | 0.10 | Titanium tetrachloride | 18.2 | | | |
| | Step (2-3 D) | A | 0.05 | Titanium tetrachloride | 18.2 | | | |
| Example | Step (2-3 A) | A | 0.60 | — | — | 1.54 | 0.27 | 0.00 |
| 22 | Step (2-3 B) | A | 0.30 | Titanium tetrachloride | 18.2 | | | |
| | Step (2-3 C) | A | 0.10 | Titanium tetrachloride | 18.2 | | | |
| | Step (2-3 D) | A | 0.05 | Titanium tetrachloride | 18.2 | | | |
| Example | Step (2-3 A) | C | 0.80 | — | — | 2.03 | 0.33 | 0.12 |
| 23 | Step (2-3 B) | C | 0.30 | Titanium tetrachloride | 18.2 | | | |
| | Step (2-3 C) | C | 0.10 | Titanium tetrachloride | 18.2 | | | |
| | Step (2-3 D) | C | 0.05 | Titanium tetrachloride | 18.2 | | | |

| | | Results of analysis of | | | | | |
|---|---|---|---|---|---|---|---|
| | | solid catalyst component | | Polymerization results | | | |
| | | Internal electron | | Polymerization | | | |
| | | donor (III) | | activity | | | |
| | | | Content | g-PP/g-solid | CXS | [η] | |
| | | Kind | % by weight | catalyst component | % by weight | dl/g | [mmmm] |
| Example | Step (2-3 A) | A | 10.7 | 26,900 | 1.4 | 0.95 | 0.967 |
| 15 | Step (2-3 B) | | | | | | |
| | Step (2-3 C) | | | | | | |
| | Step (2-3 D) | | | | | | |
| Example | Step (2-3 A) | A | 11.7 | 23,500 | 1.9 | 0.89 | 0.959 |
| 16 | Step (2-3 B) | | | | | | |
| | Step (2-3 C) | | | | | | |
| | Step (2-3 D) | | | | | | |
| Example | Step (2-3 A) | A | 8.7 | 31,800 | 2.1 | 0.98 | 0.951 |
| 17 | Step (2-3 B) | | | | | | |
| | Step (2-3 C) | | | | | | |
| | Step (2-3 D) | | | | | | |
| Example | Step (2-3 A) | A | 11.0 | 26,700 | 1.6 | 0.99 | 0.966 |
| 18 | Step (2-3 B) | | | | | | |
| | Step (2-3 C) | | | | | | |
| | Step (2-3 D) | | | | | | |
| Example | Step (2-3 A) | A | 5.5 | 6,130 | 3.2 | 0.83 | 0.944 |
| 19 | Step (2-3 B) | | | | | | |
| | Step (2-3 C) | | | | | | |
| | Step (2-3 D) | | | | | | |
| Example | Step (2-3 A) | A | 10.7 | 30,000 | 1.5 | 1.00 | 0.966 |
| 20 | Step (2-3 B) | | | | | | |
| | Step (2-3 C) | | | | | | |
| | Step (2-3 D) | | | | | | |
| Example | Step (2-3 A) | A | 8.5 | 45,300 | 0.9 | 0.99 | 0.978 |
| 21 | Step (2-3 B) | | | | | | |
| | Step (2-3 C) | | | | | | |
| | Step (2-3 D) | | | | | | |
| Example | Step (2-3 A) | A | 8.2 | 35,600 | 1.1 | 0.98 | 0.976 |
| 22 | Step (2-3 B) | | | | | | |
| | Step (2-3 C) | | | | | | |
| | Step (2-3 D) | | | | | | |
| Example | Step (2-3 A) | C | 9.0 | 21,800 | 1.6 | 1.00 | 0.966 |
| 23 | Step (2-3 B) | | | | | | |
| | Step (2-3 C) | | | | | | |
| | Step (2-3 D) | | | | | | |

Internal electron donor (III) addition amount unit: ml/g of precursor of solid catalyst component
Halogenated metal compound addition amount unit: mmol/g of precursor of solid catalyst component
A = ethyl 3-ethoxy-2-tert-butylpropionate
C = ethyl 3-ethoxy-2-phenylpropionate

### Example 24

### (1) Synthesis of Solid Catalyst Component for Olefin Polymerization

Step (2-1 A): After the atmosphere in a 100 ml-flask equipped with a stirrer, a dropping funnel, and a thermometer was replaced by nitrogen, a slurry containing a precursor of a solid catalyst component for olefin polymerization described in Example 1 (1) of JP-A-2004-182981 and toluene was added to the flask so that the amount of the precursor might be 8.00 g. From the slurry was removed toluene to adjust the slurry concentration to 0.40 g of the precursor of the solid catalyst per ml of the solvent. The temperature of the slurry in the flask was adjusted to 70° C., and the slurry was stirred for 30 minutes. Subsequently, the temperature of the stirred slurry in the flask was adjusted to 20° C., and 19.2 ml of titanium tetrachloride and 4.8 ml of a mixture of 3-ethoxy-2-tert-butylpropionyl chloride and toluene (the ratio of 3-ethoxy-2-tert-butylpropionyl chloride and toluene being 1:1 by volume) were added to the flask to form a mixture. After that, the temperature of the mixture in the flask was elevated to 105° C., and the mixture in the flask was stirred at the same temperature for 5 hours. Next, solid-liquid separation of the stirred mixture was performed to give a solid. The solid was washed with 40 ml of toluene three times at 105° C.

Step (2-1 B): To the washed solid was added 17 ml of toluene to form a slurry. To the slurry were added a mixture of 6.4 ml of titanium tetrachloride and 0.8 ml of dibutyl ether, and 0.8 ml of ethyl 3-ethoxy-2-tert-butylpropionate to form a mixture, and the mixture was stirred at 100° C. for 2 hours. After that, solid-liquid separation of the stirred mixture was performed to give a solid. The solid was washed with 40 ml of toluene twice at 100° C.

Step (2-1 C): To the washed solid was added 17 ml of toluene to form a slurry. To the slurry was added a mixture of 6.4 ml of titanium tetrachloride and 0.8 ml of dibutyl ether to form a mixture, and the mixture was stirred at 105° C. for 1 hour. After that, solid-liquid separation of the stirred mixture was performed to obtain a solid. The obtained solid was washed three times with 40 ml of toluene at 105° C., and additionally with 40 ml of hexane three times at room temperature. The washed solid was dried under reduced pressure, so that 7.84 g of a solid catalyst component for olefin polymerization was obtained. The results of the analysis of the solid catalyst component for olefin polymerization are shown in Table 4.

### (2) Polymerization of Propylene

The same procedure as in Example 1 (3) was performed except that 11.5 mg of the solid catalyst component for olefin polymerization synthesized in Example 24 (1) was used as the solid catalyst component, so that 338 g of a propylene polymer was obtained. The polymerization activity was 29,500 g-PP/g-solid catalyst component. The polymer had a CXS of 1.1% by weight, an [η] of 1.01 dl/g, and an [mmmm] of 0.963. The obtained results are shown in Table 4.

### Example 25

### (1) Synthesis of Solid Catalyst Component for Olefin Polymerization

Step (2-1 A): The same procedure as in Step (2-1 A) of Example 24 (1) was performed, except that the amount of titanium tetrachloride used was changed to 16 ml; the temperature in the flask after addition of titanium tetrachloride and the mixture of 3-ethoxy-2-tert-butylpropionyl chloride and toluene was changed to 115° C.; the stirring time after addition of titanium tetrachloride and the mixture of 3-ethoxy-2-tert-butylpropionyl chloride and toluene was changed to 4 hours; and the temperature at which washing a solid with toluene was performed was changed to 115° C.

Step (2-1 B): The same procedure as in Step (2-1 B) of Example 24 (1) was performed, except that the amount of ethyl 3-ethoxy-2-tert-butylpropionate used was changed to 0.4 ml; the temperature in the flask was changed to 110° C., the stirring time was changed to 1 hour; and the temperature at which washing a solid with toluene was performed was changed to 110° C.

Step (2-1 C): The same procedure as in Step (2-1 C) of Example 24 (1) was performed, so that 7.62 g of a solid catalyst component for olefin polymerization was obtained. The results of the analysis of the solid catalyst component for olefin polymerization are shown in Table 4.

### (2) Polymerization of Propylene

The same procedure as in Example 1 (3) was performed except that 10.1 mg of the solid catalyst component for olefin polymerization synthesized in Example 23 (1) was used as the solid catalyst component, so that 312 g of a propylene polymer was obtained. The polymerization activity was 30,900 g-PP/g-solid catalyst component. The polymer had a CXS of 1.3% by weight, an [η] of 0.94 dl/g, and an [mmmm] of 0.965. The obtained results are shown in Table 4.

### Example 26

### (1) Synthesis of Solid Catalyst Component for Olefin Polymerization

Step (2-1 A): The same procedure as in Step (2-1 A) of Example 24 (1) was performed, except that the amount of titanium tetrachloride used was changed to 16 ml; the mixture of 3-ethoxy-2-tert-butylpropionyl chloride and toluene was used in an amount of 3.2 ml; the temperature in the flask after the addition of titanium tetrachloride and the mixture of 3-ethoxy-2-tert-butylpropionyl chloride and toluene was changed to 115° C.; the stirring time was changed to 4 hours; and the temperature at which washing a solid with toluene was performed was changed to 115° C.

Step (2-1 B): The same procedure as in Step (2-1 B) of Example 24 (1) was performed, except that the temperature in the flask was changed to 110° C., the stirring time was changed to 1 hour; and the temperature at which washing a solid with toluene was performed was changed to 110° C.

Step (2-1 C): The same procedure as in Step (2-1 C) of Example 24 (1) was performed, so that 7.62 g of a solid catalyst component for olefin polymerization was obtained. The results of the analysis of the solid catalyst component for olefin polymerization are shown in Table 4.

### (2) Polymerization of Propylene

The same procedure as in Example 1 (3) was performed except that 9.42 mg of the solid catalyst component for olefin polymerization synthesized in Example 26 (1) was used as the solid catalyst component, so that 286 g of a propylene polymer was obtained. The polymerization activity was 30,400 g-PP/g-solid catalyst component. The polymer had a CXS of 1.4% by weight, an [η] of 0.95 dl/g, and an [mmmm] of 0.960. The obtained results are shown in Table 4.

### Example 27

### (1) Synthesis of Solid Catalyst Component for Olefin Polymerization

Step (2-1 A): The same procedure as in Step (2-1 A) of Example 24 (1) was performed, except that the amount of titanium tetrachloride used was changed to 16 ml; the mixture of 3-ethoxy-2-tert-butylpropionyl chloride and toluene was used in an amount of 3.2 ml; the temperature in the flask after the addition of titanium tetrachloride and the mixture of 3-ethoxy-2-tert-butylpropionyl chloride and toluene was changed to 110° C.; and the temperature at which washing a solid with toluene was performed was changed to 110° C.

Step (2-1 B): The same procedure as in Step (2-1 B) of Example 24 (1) was performed, except that the amount of ethyl 3-ethoxy-2-tert-butylpropionate used was changed to 1.2 ml; and the stirring time was changed to 1 hour.

Step (2-1 C): The same procedure as in Step (2-1 C) of Example 24 (1) was performed, so that 7.74 g of a solid catalyst component for olefin polymerization was obtained. The results of the analysis of the solid catalyst component for olefin polymerization are shown in Table 4.

### (2) Polymerization of Propylene

The same procedure as in Example 1 (3) was performed except that 8.58 mg of the solid catalyst component for olefin polymerization synthesized in Example 27 (1) was used as the solid catalyst component, so that 223 g of a propylene polymer was obtained. The polymerization activity was 26,000 g-PP/g-solid catalyst component. The polymer had a CXS of 1.2% by weight, an [η] of 0.99 dl/g, and an [mmmm] of 0.958. The obtained results are shown in Table 4.

### Example 28

### (1) Synthesis of Solid Catalyst Component for Olefin Polymerization

Step (2-1 A): The same procedure as in Step (2-1 A) of Example 24 (1) was performed, except that the temperature at which the slurry of the precursor of the solid catalyst component for olefin polymerization was stirred for 30 minutes was changed to 80° C.; titanium tetrachloride was used in an amount of 16 ml; the mixture of 3-ethoxy-2-tert-butylpropionyl chloride and toluene was used in an amount of 3.2 ml; the temperature in the flask after the addition of titanium tetrachloride and the mixture of 3-ethoxy-2-tert-butylpropionyl chloride and toluene was changed to 110° C.; the stirring time was changed to 3 hours; and the temperature at which washing a solid with toluene was performed was changed to 110° C.

Step (2-1 B): The same procedure as in Step (2-1 B) of Example 24 (1) was performed, except that the amount of ethyl 3-ethoxy-2-tert-butylpropionate used was changed to 0.4 ml; the temperature in the flask was changed to 105° C., the stirring time was changed to 1 hour; and the temperature at which washing a solid with toluene was performed was changed to 105° C.

Step (2-1 C): The same procedure as in Step (2-1 C) of Example 24 (1) was performed, so that 7.81 g of a solid catalyst component for olefin polymerization was obtained. The results of the analysis of the solid catalyst component for olefin polymerization are shown in Table 4.

### (2) Polymerization of Propylene

The same procedure as in Example 1 (3) was performed except that 6.50 mg of the solid catalyst component for olefin polymerization synthesized in Example 28 (1) was used as the solid catalyst component, so that 221 g of a propylene polymer was obtained. The polymerization activity was 34,000 g-PP/g-solid catalyst component. The polymer had a CXS of 1.5% by weight, an [η] of 0.96 dl/g, and an [mmmm] of 0.956. The obtained results are shown in Table 4.

TABLE 4

| | | | | | | Results of analysis of | | |
|---|---|---|---|---|---|---|---|---|
| | | | | | | solid catalyst component | | |
| | | Synthesis conditions for solid catalyst component | | | | | Content of alkoxy | |
| | | Internal electron | | | | | groups | |
| | | donor (III) | | Halogenated metal compound | | Content of | EtO- | nBuO- |
| | | | Addition | | Addition | titanium atoms | % by | % by |
| | | Kind | amount | Kind | amount | % by weight | weight | weight |
| Example | Step (2-1 A) | D | 0.30 | Titanium tetrachloride | 21.9 | 3.18 | 0.19 | 0.09 |
| 24 | Step (2-1 B) | A | 0.10 | Titanium tetrachloride | 7.3 | | | |
| | Step (2-1 C) | — | — | Titanium tetrachloride | 7.3 | | | |
| Example | Step (2-1 A) | D | 0.30 | Titanium tetrachloride | 18.2 | 3.27 | 0.13 | 0.11 |
| 25 | Step (2-1 B) | A | 0.05 | Titanium tetrachloride | 7.3 | | | |
| | Step (2-1 C) | — | — | Titanium tetrachloride | 7.3 | | | |
| Example | Step (2-1 A) | D | 0.20 | Titanium tetrachloride | 18.2 | 3.34 | 0.18 | 0.09 |
| 26 | Step (2-1 B) | A | 0.10 | Titanium tetrachloride | 7.3 | | | |
| | Step (2-1 C) | — | — | Titanium tetrachloride | 7.3 | | | |
| Example | Step (2-1 A) | D | 0.20 | Titanium tetrachloride | 18.2 | 3.07 | 0.19 | 0.09 |
| 27 | Step (2-1 B) | A | 0.15 | Titanium tetrachloride | 7.3 | | | |
| | Step (2-1 C) | — | — | Titanium tetrachloride | 7.3 | | | |
| Example | Step (2-1 A) | D | 0.20 | Titanium tetrachloride | 18.2 | 3.48 | 0.25 | 0.12 |
| 28 | Step (2-1 B) | A | 0.05 | Titanium tetrachloride | 7.3 | | | |
| | Step (2-1 C) | — | — | Titanium tetrachloride | 7.3 | | | |

| | | Results of analysis of | | | | | |
|---|---|---|---|---|---|---|---|
| | | solid catalyst component | | Polymerization results | | | |
| | | Content of Internal | | Polymerization | | | |
| | | electron donor (III) | | activity | | | |
| | | A | E | g-PP/g-solid | CXS | [η] | |
| | | % by weight | % by weight | catalyst component | % by weight | dl/g | [mmmm] |
| Example | Step (2-1 A) | 16.6 | 0.20 | 29,500 | 1.1 | 1.01 | 0.963 |
| 24 | Step (2-1 B) | | | | | | |
| | Step (2-1 C) | | | | | | |
| Example | Step (2-1 A) | 14.9 | 0.21 | 30,890 | 1.3 | 0.94 | 0.965 |
| 25 | Step (2-1 B) | | | | | | |
| | Step (2-1 C) | | | | | | |
| Example | Step (2-1 A) | 15.1 | 0.18 | 30,400 | 1.4 | 0.95 | 0.960 |
| 26 | Step (2-1 B) | | | | | | |
| | Step (2-1 C) | | | | | | |
| Example | Step (2-1 A) | 15.9 | 0.14 | 26,000 | 1.2 | 0.99 | 0.958 |
| 27 | Step (2-1 B) | | | | | | |
| | Step (2-1 C) | | | | | | |
| Example | Step (2-1 A) | 15.8 | 0.0 | 34,000 | 1.5 | 0.96 | 0.956 |
| 28 | Step (2-1 B) | | | | | | |
| | Step (2-1 C) | | | | | | |

Internal electron donor (III) addition amount unit: ml/g of precursor of solid catalyst component
Halogenated metal compound addition amount unit: mmol/g of precursor of solid catalyst component
A = ethyl 3-ethoxy-2-tert-butylpropionate
D = 3-ethoxy-2-tert-butylpropionyl chloride
E = butyl 3-ethoxy-2-tert-butylpropionate

1. A process for producing a solid catalyst component (A) for olefin polymerization, the process comprising:
step (1) of producing a precursor of the solid catalyst component by adding an organomagnesium compound (c) to a titanium compound (b) represented by Formula (I) in the presence of a silicon compound containing a Si—O bond (a), 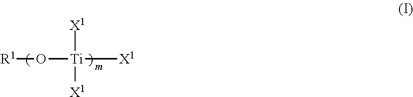
where m is an integer number of 1 to 20; R1 is a hydrocarbyl group having 1 to 20 carbon atoms; X1 each independently is a halogen atom or a hydrocarbyloxy group having 1 to 20 carbon atoms, and
step (2) of producing the solid catalyst component (A) by bringing the precursor of the solid catalyst component, a halogenated metal compound represented by Formula (II) and an internal electron donor represented by Formula (III) into contact with each other,
MX²_{b}(R²)_{m-b} (II)
where M is a Group 4 element, a Group 13 element or a Group 14 element; R² is an alkyl group, an aryl group, an alkoxy group or an aryloxy group each having 1 to 20 carbon atoms; X² is a halogen atom; m is the valency of M; b is an integer number satisfying 0<b≦m, 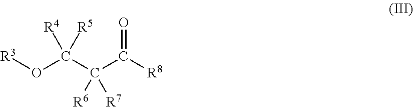
where R³ is a hydrocarbyl group having 1 to 20 carbon atoms; R⁴, R⁵, R⁶ and R⁷ are each independently a hydrogen atom, a halogen atom or a hydrocarbyl group having 1 to 20 carbon atoms; and R⁸ is a halogen atom or a hydrocarbyloxy group having 1 to 20 carbon atoms.

2. The process according to claim 1, wherein R⁴ and R⁵ are hydrogen atoms.

3. The process according to claim 1, wherein R⁶ is an alkyl group having 1 to 20 carbon atoms or an aryl group having 6 to 20 carbon atoms.

4. The process according to claim 3, wherein R⁶ is a branched or cyclic alkyl group having 3 to 20 carbon atoms or an aryl group having 6 to 20 carbon atoms.

5. A process for producing a solid catalyst for olefin polymerization, the process comprising a step of bringing a solid catalyst component (A) produced by the process according to claim 1 into contact with an organoaluminum compound (B).

6. A process for producing a solid catalyst for olefin polymerization, the process comprising a step of bringing a solid catalyst component (A) produced by the process according to claim 1, an organoaluminum compound (B) and an external electron donor (C) into contact with each other.

7. A process for producing an olefin polymer, the process comprising a step of polymerizing an olefin in the presence of a solid catalyst produced by the process according to claim 5.

8. A process for producing an olefin polymer, the process comprising a step of polymerizing an olefin in the presence of a solid catalyst produced by the process according to claim 6.

9. The process for producing an olefin polymer according to claim 7, wherein the olefin is an α-olefin having 3 to 20 carbon atoms.

10. The process for producing an olefin polymer according to claim 8, wherein the olefin is an α-olefin having 3 to 20 carbon atoms.

11. The process according to claim 2, wherein R⁶ is an alkyl group having 1 to 20 carbon atoms or an aryl group having 6 to 20 carbon atoms.

12. A process for producing a solid catalyst for olefin polymerization, the process comprising a step of bringing a solid catalyst component (A) produced by the process according to claim 2 into contact with an organoaluminum compound (B).

13. A process for producing a solid catalyst for olefin polymerization, the process comprising a step of bringing a solid catalyst component (A) produced by the process according to claim 2, an organoaluminum compound (B) and an external electron donor (C) into contact with each other.
